(19) United States
(12) Patent Application Publication
(10) Pub. No.: US 2026/0369052 A1
(43) Pub. Date: Nov. 19, 2026

(54) INFORMATION PROCESSING SYSTEM, INFORMATION PROCESSING METHOD, AND MEDIUM

(71) Applicant: NEC Corporation, Minato-ku, Tokyo (JP)

(72) Inventors: Yuho SHOJI, Tokyo (JP); Takahiro TOIZUMI, Tokyo (JP)

(73) Assignee: NEC Corporation, Minato-ku, Tokyo (JP)

(21) Appl. No.: 19/121,871

(22) PCT Filed: Mar. 3, 2023
(86) PCT No.: PCT/JP2023/008146

§ 371 Date: Apr. 17, 2025

(30) Foreign Application Priority Data
Nov. 4, 2022 (WO) PCT/JP2022/041157

(51) Int. Cl. G06V 10/98; G06V 10/82; G06V 40/18

(52) U.S. Cl. CPC G06V 10/993; G06V 10/82; G06V 40/193

(57) ABSTRACT

An information processing system (100) includes a quality estimation unit (111) and an image processing unit (113). The quality estimation unit (111) estimates quality information of a target image. The image processing unit (113) processes the target image by use of a neural network according to a network policy determined based on the quality information of the target image.

### TECHNICAL FIELD

This disclosure relates to an information processing system, an information processing apparatus, an information processing method, and a recording medium.

### BACKGROUND ART

In iris recognition, recognition performance may generally deteriorate in a case where quality, such as resolution, of an image is low. Thus, in iris recognition, it is desirable to capture a recognition target by use of a high-resolution capture apparatus, but it may be difficult to use a high-resolution capture apparatus due to an installation space, cost, and the like of the capture apparatus.

For example, Patent Document 1 discloses, during execution of iris recognition, using a predetermined number of capture images, and generating an image for iris recognition with second resolution higher than first resolution of the capture image. As an example thereof, Patent Document 1 discloses converting, from eight consecutively captured capture images, 1×1 pixels of the capture images into 2×2 pixels, and generating an image for recognition with double resolution.

### RELATED DOCUMENT

### Patent Document

Patent Document 1: Japanese Patent Application Publication No. 2009-282925

### SUMMARY

### Technical Problem

This disclosure aims to ameliorate a technique described in the related document described above.

### Solution to Problem

According to one aspect of the present invention, there is provided an information processing system including:
a quality estimation unit that estimates quality information of a target image; and
an image processing unit that processes the target image by use of a neural network according to a network policy determined based on the quality information of the target image.

According to one aspect of the present invention, there is provided an information processing apparatus including:
a quality estimation unit that estimates quality information of a target image; and
an image processing unit that processes the target image by use of a neural network according to a network policy determined based on the quality information of the target image.

According to one aspect of the present invention, there is provided an information processing method including,
by one or more computers:
estimating quality information of a target image; and
processing the target image by use of a neural network according to a network policy determined based on the quality information of the target image.

According to one aspect of the present invention, there is provided a medium recording a program for causing one or more computers to execute:
estimating quality information of a target image; and
processing the target image by use of a neural network according to a network policy determined based on the quality information of the target image.

### BRIEF DESCRIPTION OF THE DRAWINGS

FIG. 1 is a diagram illustrating an outline of an information processing system according to a first example embodiment.

FIG. 2 is a diagram illustrating an outline of an information processing apparatus according to the first example embodiment.

FIG. 3 is a flowchart illustrating an outline of information processing according to the first example embodiment.

FIG. 4 is a diagram illustrating a configuration example of an information processing system according to the first example embodiment.

FIG. 5 is a diagram illustrating a configuration example of a neural network according to the first example embodiment.

FIG. 6 is a diagram illustrating a physical configuration example of the information processing apparatus according to the first example embodiment.

FIG. 7 is a flowchart illustrating one example of information processing according to the first example embodiment.

FIG. 8 is a diagram illustrating one example of a target image according to the first example embodiment.

FIG. 9 is a diagram illustrating a functional configuration example of an image processing unit according to a second example embodiment.

FIG. 10 is a diagram illustrating a configuration example of a neural network according to the second example embodiment.

FIG. 11 is a flowchart illustrating a detailed example of image processing according to the second example embodiment.

FIG. 12 is a diagram illustrating one example of an iris region according to the second example embodiment.

FIG. 13 is a diagram illustrating one example of a standard image according to the second example embodiment.

FIG. 14 is a diagram illustrating a configuration example of a neural network according to a third example embodiment.

FIG. 15 is a diagram illustrating a configuration example of an information processing system according to a fourth example embodiment.

FIG. 16 is a flowchart illustrating one example of training processing according to the fourth example embodiment.

FIG. 17 is a diagram illustrating one example of a probability distribution for training according to the fourth example embodiment.

FIG. 18 is a diagram illustrating a configuration example of an information processing system according to a fifth example embodiment.

FIG. 19 is a flowchart illustrating one example of training processing according to the fifth example embodiment.

FIG. 20 is a diagram illustrating one example of a probability distribution for selection according to the fifth example embodiment.

FIG. 21 is a diagram illustrating a configuration example of an information processing system according to a sixth example embodiment.

FIG. 22 is a flowchart illustrating one example of training processing according to the sixth example embodiment.

FIG. 23 is a diagram illustrating a configuration example of an information processing system according to a seventh example embodiment.

FIG. 24 is a flowchart illustrating one example of information processing according to the seventh example embodiment.

FIG. 25 is a flowchart illustrating an example of network policy determination processing according to the seventh example embodiment.

FIG. 26 is a diagram illustrating a configuration example of an information processing system according to an eighth example embodiment.

FIG. 27 is a flowchart illustrating one example of training processing according to the eighth example embodiment.

FIG. 28 is a diagram illustrating a configuration example of a policy-for-training determination unit according to a ninth example embodiment.

FIG. 29 is a flowchart illustrating an example of a first policy determination model training processing according to a ninth example embodiment.

FIG. 30 is a diagram illustrating a configuration example of an information processing system according to a tenth example embodiment.

FIG. 31 is a flowchart illustrating one example of information processing according to the tenth example embodiment.

FIG. 32 is a flowchart illustrating an example of network policy determination processing according to the tenth example embodiment.

FIG. 33 is a diagram illustrating a configuration example of an information processing system according to an eleventh example embodiment.

FIG. 34 is a diagram illustrating a functional configuration example of a policy-for-training determination unit according to the eleventh example embodiment.

FIG. 35 is a flowchart illustrating an example of second policy determination model training processing according to the eleventh example embodiment.

FIG. 36 is a diagram illustrating a configuration example of an information processing system according to a twelfth example embodiment.

FIG. 37 is a flowchart illustrating one example of information processing according to the twelfth example embodiment.

FIG. 38 is a flowchart illustrating an example of network policy determination processing according to a twelfth example embodiment.

FIG. 39 is a diagram illustrating a configuration example of an information processing system according to a thirteenth example embodiment.

FIG. 40 is a diagram illustrating a functional configuration example of a policy-for-training determination unit according to the thirteenth example embodiment.

FIG. 41 is a flowchart illustrating an example of third policy determination model training processing according to the thirteenth example embodiment.

### EXAMPLE EMBODIMENT

Hereinafter, one example embodiment of the present invention is described by use of the drawings. Note that, in all of the drawings, a similar component is assigned with a similar reference sign, and description thereof is omitted as appropriate.

### First Example Embodiment

### (Outline)

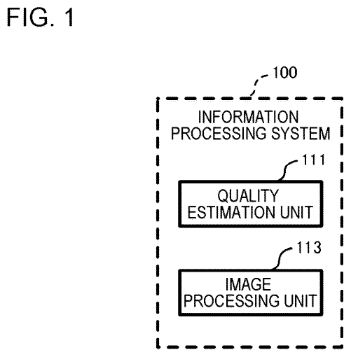

FIG. 1 is a diagram illustrating an outline of an information processing system 100 according to a first example embodiment. The information processing system 100 includes a quality estimation unit 111 and an image processing unit 113.

The quality estimation unit 111 estimates quality information of the target image. The image processing unit 113 processes the target image by use of a neural network according to a network policy determined based on the quality information of the target image.

According to the information processing system 100, it becomes possible to perform recognition regardless of quality of a target image while suppressing an increase in a processing time.

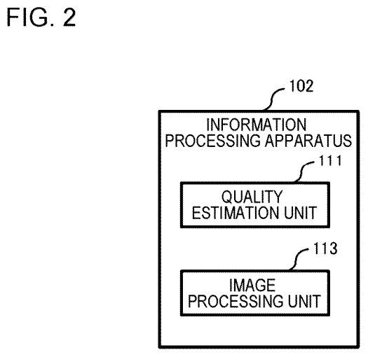

FIG. 2 is a diagram illustrating an outline of the information processing apparatus 102 according to the first example embodiment. The information processing apparatus 102 includes a quality estimation unit 111 and an image processing unit 113.

The quality estimation unit 111 estimates quality information of a target image. The image processing unit 113 processes the target image by use of a neural network according to a network policy determined based on the quality information of the target image.

According to the information processing apparatus 102, it becomes possible to perform recognition regardless of quality of a target image while suppressing an increase in a processing time.

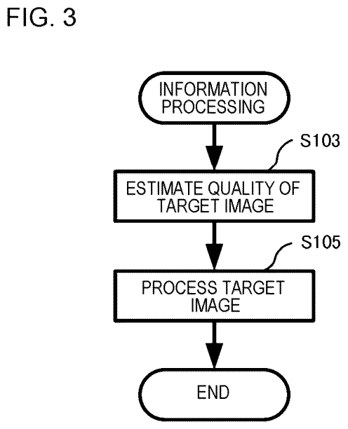

FIG. 3 is a flowchart illustrating an outline of information processing according to the first example embodiment.

The quality estimation unit 111 estimates quality information of a target image (step S103).

The image processing unit 113 processes the target image by use of a neural network according to a network policy determined based on the quality information of the target image (step S105).

According to the information processing, it becomes possible to perform recognition regardless of quality of a target image while suppressing an increase in a processing time.

Hereinafter, a detailed example of the information processing system 100 according to the first example embodiment is described.

### (Details)

A technique described in Patent Document 1 described above uses a so-called image super-resolution technique in order to improve resolution. However, image super-resolution has a problem that a time for performing the processing becomes long.

In view of these circumstances, one example of an object of this disclosure is to provide an information processing system, an information processing apparatus, an information processing method, and a medium that solve performing recognition regardless of quality of a target image while suppressing an increase in a processing time.

### (Configuration Example of the Information Processing System 100 According to the First Example Embodiment)

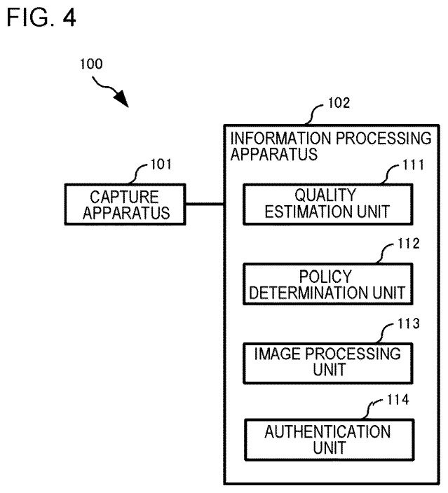

FIG. 4 is a diagram illustrating a configuration example of the information processing system 100 according to the first example embodiment. The information processing system 100 is a system for performing processing by use of a target image capturing a target. The present example embodiment is described by use of an example in which processing using a target image is recognition processing of authenticating the target.

The information processing system 100 includes a capture apparatus 101 and the information processing apparatus 102.

It is preferable that the capture apparatus 101 and the information processing apparatus 102 are connected wiredly, wirelessly, or via a network configured by combining the wired and wireless ways, and transmit and receive information to and from each other via the network.

A target according to the present example embodiment is a person. Note that, a target is not limited thereto, and may be, for example, an animal such as a dog or a snake.

Moreover, in recognition processing according to the present example embodiment, iris recognition is performed. The present example embodiment is described by use of an example in which iris recognition performed by use of an image of a right eye iris. Note that, recognition processing is not limited thereto, and may be, for example, recognition processing using an image, such as iris recognition using an image of a left eye iris or irises of both eyes, face recognition using a face image showing the entire face, or vein recognition using an image showing a vein.

The capture apparatus 101 captures a target, and generates a target image.

A target image is an image including a target region used in recognition processing. In the present example embodiment, since iris recognition is performed by use of an image as described above, a target region is an iris region where the iris is shown. More specifically, in the present example embodiment, since iris recognition is performed by use of an image of a right eye iris, a target region is an iris region where the right eye iris is shown. Note that, iris recognition may be performed by use of an image of a left eye iris, and a target region in this case may be an iris region where a right eye iris is shown.

### (Functional Configuration Example of the Information Processing Apparatus 102 According to the First Example Embodiment)

The information processing apparatus 102 according to the present example embodiment performs, by use of a target image generated by the capture apparatus 101, recognition of a target shown in a target image.

Note that, the present example embodiment is described by use of an example in which the information processing apparatus 102 includes a recognition unit 114 that performs processing (recognition processing) for authenticating a target as described later, but the information processing apparatus 102 may only perform processing for authenticating a target by use of a target image, and recognition processing may be performed, for example, by another non-illustrated information processing apparatus. In this case, it is preferable that the another information processing apparatus includes the recognition unit 114.

As illustrated in FIG. 4, the information processing apparatus 102 functionally includes, for example, a quality estimation unit 111, a policy determination unit 112, an image processing unit 113, and the recognition unit 114.

The quality estimation unit 111 estimates quality information of a target image.

The quality information is information indicating quality of the target image. Quality according to the present example embodiment is resolution of a target image, and is, for example, resolution of a target region included in a target image. Specifically, quality according to the present example embodiment is resolution of an iris region where a right eye iris used in recognition processing is shown. In a case where quality is resolution, quality becomes lower as resolution is smaller.

The quality estimation unit 111 may further estimate a target region position in a target image. The target region position is information for specifying a position of a target region in the target image. In the present example embodiment, since a target region is the iris region described above, a target region position according to the present example embodiment is a position of a right eye iris in the target image. Hereinafter, the position of the right eye iris in the target image is also referred to as an “eye position”.

An eye position includes, for example, a position of a pupil center, a pupil diameter, and an iris diameter. The pupil diameter is a diameter or a radius of a pupil. Moreover, the iris diameter is a diameter or a radius of an iris outer edge. By using such an eye position, a position of a right eye iris in a target image can be determined.

Note that, quality indicated by quality information is not limited to resolution of a target image, but may be, for example, one or a plurality of resolution of the target image, an iris diameter of an iris shown in the target image, an estimated distance between the capture apparatus 101 and a target, presence or absence or a degree of blur, and the like. The estimated distance may be estimated from information used for focus adjustment in the capture apparatus 101, or may be estimated based on information from a distance measurement sensor (not illustrated) for estimating a distance to a target. Moreover, resolution of the target image is not limited to a target region, but may be, for example, the resolution or the like of a predetermined region included in a target image.

Moreover, quality information may also be represented by, for example, a vector amount. In a case where quality information is represented by a plurality of parameters, the plurality of parameters can be handled as a single variable by representing the quality information by use of a vector amount.

The policy determination unit 112 determines a network policy, based on the quality information estimated by the quality estimation unit 111. The network policy is applied to a neural network used for image processing by the image processing unit 113 described later.

It is preferable that the policy determination unit 112 determines, for example, such a network policy that at least one of (A) and (B) below is satisfied, regardless of quality information of a target image.

(A) is that a time of processing using a neural network falls within a previously determined range. (B) is that recognition performance using a target image falls within a previously determined range.

The image processing unit 113 processes the target image by use of a neural network according to the network policy determined by the policy determination unit 112. In processing of the target image, the image processing unit 113 according to the present example embodiment extracts, for example, a feature vector from the target image.

Herein, it is preferable that, for example, the image processing unit 113 processes, according to the network policy, the target image by use of a neural network that performs an arithmetic operation by use of more detailed information as quality of the target image (i.e., quality indicated by quality information) is lower. In other words, the policy determination unit 112 determines a network policy that performs an arithmetic operation by use of more detailed information as quality of the target image is lower.

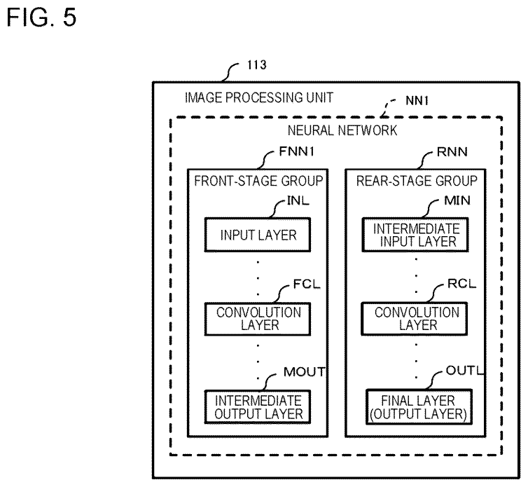

FIG. 5 is a diagram illustrating a configuration example of a neural network NN1 according to the first example embodiment. The neural network NN1 is used for processing of a target image performed by the image processing unit 113. Herein, description is given by use of an example in which the neural network NN1 is a convolution neural network. Note that, the neural network NN1 is not limited thereto, and, for example, a vision transformer or the like may be adopted.

The neural network NN1 includes, for example, a plurality of layers. The plurality of layers included in the neural network NN1 are made up of a front-stage group FNN1 including an input layer INL and a rear-stage group RNN including a final layer OUTL.

The number of layers included in each of the front-stage group FNN1 and the rear-stage group RNN may be changed as appropriate, but for example, the number of layers included in the front-stage group FNN1 may be larger than the number of layers included in the rear-stage group RNN. That is to say, the front-stage group FNN1 may be closer to an input side than a layer located in a middle of a plurality of layers making up the neural network NN1.

The front-stage group FNN1 includes, for example, an input layer INL, at least one convolution layer FCL, and an intermediate output layer MOUT. Note that, the front-stage group FNN1 may include a non-illustrated batch norm layer, an activation function, and the like, similar to a typical convolution neural network.

The input layer INL acquires an input image to the neural network NN1, and propagates the input image to, for example, a subsequent layer. The input image is a target image. Note that, the image processing unit 113 may extract an image (e.g., an image of a target region) included in a target image, and use the extracted image as the input image. That is to say, the input image may be any image acquired from the target image.

Each layer including the convolution layer FCL processes the input image, and extracts, for example, a feature vector of the input image. The intermediate output layer MOUT outputs a processing result in the neural network NN1 as an intermediate feature vector. Note that, the intermediate output layer MOUT may be a convolution layer.

Herein, the network policy determined by the policy determination unit 112 is applied to image processing using the front-stage group FNN1. In other words, the policy determination unit 112 determines a network policy to be applied to the front-stage group FNN1. Specifically, for example, as quality of the target image is lower, the policy determination unit 112 determines a network policy that performs an arithmetic operation by use of more detailed information.

In this instance, the policy determination unit 112 may determine such a network policy as to satisfy at least one of (A) and (B) described above. For example, the policy determination unit 112 may previously hold policy information defining a network policy according to quality of a target image, acquire the network policy according to the quality of the target image from the policy information, and thereby determine a network policy according to the quality of the target image. It is preferable that, in the policy information, for example, a network policy in which the front-stage group FNN1 performs an arithmetic operation using detailed information according to the quality of the target image is previously determined in such a way as to satisfy at least one of (A) and (B) described above.

The rear-stage group RNN includes, for example, an intermediate input layer MIN, at least one convolution layer RCL, and a final layer (output layer) OUTL. Note that, the rear-stage group RNN may include a non-illustrated batch norm layer, an activation function, and the like, similar to a general convolution neural network.

The intermediate input layer MIN acquires an intermediate feature vector from the front-stage group FNN1. Each layer including the convolution layer RCL further processes the intermediate feature vector, and extracts, for example, a feature vector of the input image. Note that, the intermediate input layer MIN may be a convolution layer.

The final layer OUTL outputs a final processing result in the neural network NN1. The final layer OUTL outputs, for example, a feature vector based on a result of further processing in each layer including the convolution layer RCL.

In this way, by performing an arithmetic operation by use of more detailed information as quality of the target image is lower, deterioration of recognition performance performed in recognition processing can be suppressed even with a low-quality target image. On the other hand, since an arithmetic operation is performed by use of detailed information, a time of processing using a neural network increases for a low-quality target image as compared to a high-quality target image.

As described above, for example, the policy determination unit 112 may determine a network policy (A) in such a way that a time of processing using a neural network falls within a previously determined range, regardless of quality information (i.e., quality indicated by quality information) of a target image. Thereby, an increase in a processing time (a processing time using a neural network) in a case where a target image is of low quality can be suppressed, and a time of processing using a neural network can be at the same degree regardless of quality of the target image.

Moreover, for example, the policy determination unit 112 may determine a network policy (B) in such a way that recognition performance using a target image falls within a previously determined range, regardless of quality information (i.e., quality indicated by the quality information) of the target image. Thereby, deterioration of recognition performance in a case where the target image is of low quality can be suppressed, and recognition performance performed in recognition processing can be at the same degree regardless of quality of the target image.

The recognition unit 114 performs recognition processing by use of a result of processing the target image by the image processing unit 113. The recognition processing is processing of authenticating a target by use of the result of processing the target image.

For example, once a feature vector extracted by the image processing unit 113 is acquired, the recognition unit 114 performs recognition of the target, based on whether the acquired feature vector is registered in registration data. Although not illustrated, it is preferable that the recognition unit 114 previously holds the registration data.

A functional configuration example of the information processing system 100 has been described so far. From now on, a physical configuration example of the information processing system 100 is described.

### (Physical Configuration of the Information Processing System 100)

The information processing system 100 according to the present example embodiment is physically made up of, for example, the capture apparatus 101 and the information processing apparatus 102. The capture apparatus 101 is, for example, a camera such as a near-infrared camera.

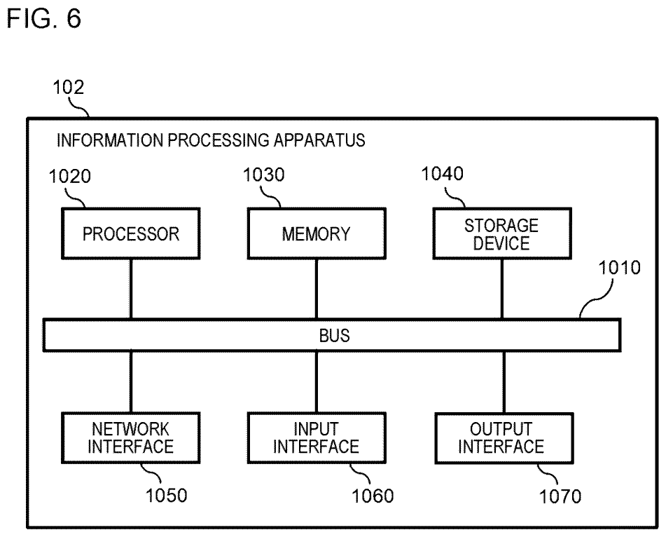

FIG. 6 is a diagram illustrating a physical configuration example of the information processing apparatus 102 according to the first example embodiment. The information processing apparatus 102 includes a bus 1010, a processor 1020, a memory 1030, a storage device 1040, a network interface 1050, an input interface 1060, and an output interface 1070.

The bus 1010 is a data transmission path through which the processor 1020, the memory 1030, the storage device 1040, the network interface 1050, the input interface 1060, and the output interface 1070 transmit/receive data to/from one another. However, a method of mutually connecting the processor 1020 and the like is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module for achieving a function of the information processing apparatus 102. The processor 1020 reads each of the program modules onto the memory 1030, executes the read program module, and thereby achieves each function being relevant to the program module.

The network interface 1050 is an interface for connecting the information processing apparatus 102 to a network.

The input interface 1060 is an interface for a user to input information, and is made up of, for example, a touch panel, a keyboard, a mouse, and the like.

The output interface 1070 is an interface for presenting information to the user, and is made up of, for example, a liquid crystal panel, an organic electro-luminescence (EL) panel, and the like.

Note that, the function of the information processing apparatus 102 may be physically achieved by use of a plurality of information processing apparatuses. Each of the information processing apparatuses in this case may be physically configured, for example, similarly to the information processing apparatus 102 illustrated in FIG. 6. Moreover, it is preferable that a plurality of information processing apparatuses are connected to each other wiredly, wirelessly, or via a network configured by combining the wired and wireless ways, and are configured to be able to transmit and receive information to and from each other via the network.

The configuration example of the information processing system 100 according to the first example embodiment has been described so far. From now on, an operation example of the information processing system 100 according to the first example embodiment is described.

(Operation Example of the Information Processing System 100 According to the First Example embodiment)

The information processing system 100 executes information processing. The information processing according to the present example embodiment is processing of performing recognition of a target shown in a target image by use of a target image capturing the target.

Note that, the present example embodiment is described by use of an example in which information processing includes recognition processing of performing recognition of a target, but the information processing may be processing for authenticating a target by use of a target image, and may not include recognition processing.

It is preferable that information processing is started, for example, by accepting a signal from a non-illustrated sensor. The sensor is, for example, a sensor that senses presence or entry of a person into a region captured by the capture apparatus 101. Note that, a method of starting information processing is not limited thereto.

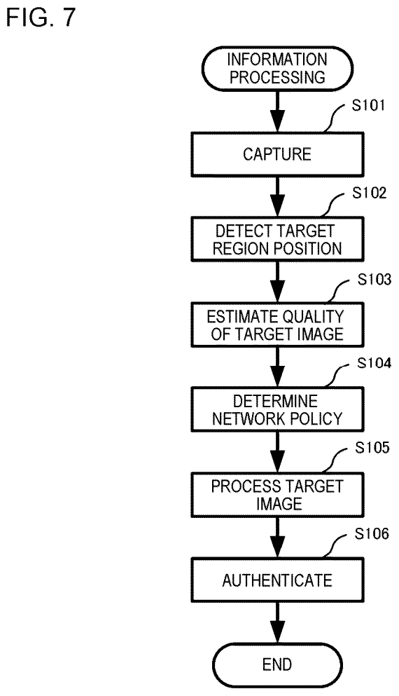

FIG. 7 is a flowchart illustrating one example of information processing according to the first example embodiment.

The capture apparatus 101 captures a target (step S101). Thereby, the capture apparatus 101 generates a target image showing the target.

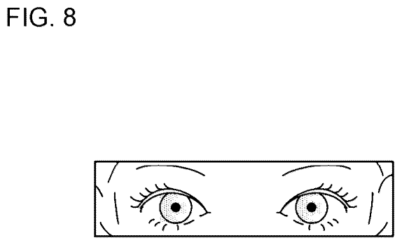

FIG. 8 is a diagram illustrating one example of a target image according to the first example embodiment. The target image according to the present example embodiment is an eye image including both eyes of a target. The eye image is one example of an image including a target region according to the present example embodiment. As described above, the target region according to the present example embodiment is an iris region in which a right eye iris is shown.

Note that, a target image may be changed variously according to a type of recognition to be performed by use of the target image, or the like. For example, in a case where face recognition is performed, it may be a face image including a face of a target and a background, an image including an upper body or an entire body of a target, or the like. The target region in this case is a target region being the facial region in which the face is shown. For example, in a case where vein recognition is performed, it may be an image including, as a target region, a region in which a vein is shown.

Moreover, for example, a target image in a case of being used for iris recognition is not limited to an eye image, but may be a face image, an image including an upper body or an entire body of a target, or the like. Further, the eye image is not limited to an eye image including both eyes of a target, but may be a single-eye image including previously determined one of left and right eyes of the target, or the like. The eye image illustrated in FIG. 8 includes not only an iris but also a pupil, white of an eye, an eyelid, an eyelash, and the like, but the eye image may include at least an iris region used in recognition processing, and may not include one or a plurality of a pupil, white of an eye, an eyelid, an eyelash, and the like.

FIG. 7 is referred to again.

The quality estimation unit 111 estimates a target region position in a target image (step S102).

The quality estimation unit 111 according to the present example embodiment estimates, from, for example, a target image, an eye position including a position of a pupil center, a pupil diameter, and an iris diameter of a right eye.

For a technique with which the quality estimation unit 111 estimates an eye position, it is preferable to use a general technique such as pattern matching and a machine learning model. In a case where a machine learning model is used, it is preferable that the quality estimation unit 111 estimates an eye position in a target image with the target image as an input by use of a learning model that has been performed training for estimating an eye position from the target image. In training of the learning model, it is preferable to perform, with a target image for training as an input, training using training data including an eye position in the target image.

The quality estimation unit 111 estimates quality of the target image (step S103). Thereby, the quality estimation unit 111 generates quality information including the quality of the target image.

The quality estimation unit 111 according to the present example embodiment determines, based on, for example, the eye position estimated in step S102, an iris region (i.e., a region showing a right eye iris of a target) included in the target image. The iris region is a substantially ring-shaped region centered on a pupil center and surrounded by a concentric circle with a diameter according to each of a pupil diameter and an iris diameter. Note that, as illustrated in FIG. 8, in a case where a part of the iris region is covered an eyelid or the like, the iris region has a shape in which a part covered by the eyelid or the like is missing from the ring-shaped region.

The quality estimation unit 111 derives resolution of the determined iris region. The resolution is, for example, an image size. In this case, the quality estimation unit 111 derives an image size of the determined iris region. The image size of the iris region is the number of pixels in the iris region.

Alternatively, the quality estimation unit 111 may derive quality of the target image by use of a learning model. It is preferable that the learning model in this case estimates quality of the target image with the target image as an input by use of a learning model that has performed training for estimating quality of the target image. Moreover, in training of the learning model, it is preferable to perform, with a target image for training as an input, training using training data including quality of the target image.

Note that, an iris diameter may be adopted for an image size. In this case, step S102 includes processing of estimating quality of the target image. Moreover, even in a case where a value other than an iris diameter is used for quality of the target image, a common learning model may be used in steps S102 and S103. It is preferable that the learning model in this case estimates an eye position and quality of the target image in the target image with the target image as an input by use of a learning model that has performed training for estimating an eye position and quality of the target image from the target image. Moreover, in training of the learning model, it is preferable to perform, with a target image for training as an input, training using training data including an eye position and quality of the target image from the target image.

The policy determination unit 112 determines a network policy, based on the quality of the target image estimated in step S103 (step S104).

Specifically, for example, the policy determination unit 112 may determine a network policy in such a way that at least one of (A) and (B) described above is satisfied, regardless of quality information of the target image.

The image processing unit 113 processes the target image by use of the neural network NN1 according to the network policy determined in step S104 (step S105).

Specifically, for example, the image processing unit 113 extracts, from the iris region estimated in step S102, a feature vector thereof, by use of the neural network NN1 according to the network policy.

Herein, for example, it is assumed that, in step S104, the policy determination unit 112 determines such a network policy as to satisfy both (A) and (B) regardless of quality information of the target image. Thereby, both a time of processing (i.e., for example, processing for extracting a feature vector) using the neural network NN1 and recognition performance performed in recognition processing can be at the same degree, regardless of quality of the target image.

The recognition unit 114 performs recognition processing by use of a result of the processing in step S105 (step S106).

Specifically, for example, the recognition unit 114 acquires the feature vector extracted by the image processing unit 113. The recognition unit 114 compares the acquired feature vector with a feature vector acquired from previously held registration data, and authenticates the target, based on a result of comparing.

More specifically, for example, the recognition unit 114 derives a similarity degree between the acquired feature vector and the feature vector acquired from the registration data. The recognition unit 114 authenticates the target, based on a result of comparing the similarity degree with a predetermined threshold value. For example, the recognition unit 114 assesses that recognition of the target is successful in a case where the similarity degree is equal to or more than the threshold value. Moreover, for example, the recognition unit 114 assesses that the recognition of the target is unsuccessful in a case where the similarity degree is less than the threshold value. Note that, a method of recognition is not limited thereto, and a general method may be used.

### (Action and Effect)

As described above, according to the present example embodiment, the information processing system 100 includes the quality estimation unit 111 and the image processing unit 113.

The quality estimation unit 111 estimates quality information of a target image. The image processing unit 113 processes the target image by use of the neural network NN1 according to a network policy determined based on quality information of the target image.

Thereby, processing in the neural network NN1 can be changed according to quality of the target image. Therefore, it becomes possible to perform recognition regardless of the quality of the target image while suppressing an increase in a processing time.

According to the present example embodiment, the image processing unit 113 extracts a feature vector from the target image by use of the neural network NN1 according to the network policy.

Thereby, recognition processing can be performed by use of a feature vector. Processing for extracting a feature vector is performed by use of the neural network NN1 according to the network policy. Therefore, it becomes possible to perform recognition regardless of quality of a target image while suppressing an increase in a processing time.

In the present example embodiment, a target image is an eye image including an iris region in which the iris is shown. Quality information includes an iris diameter.

Thereby, processing in the neural network NN1 can be changed according to the iris diameter of the target image. Therefore, it becomes possible to perform recognition such as iris recognition regardless of quality of a target image while suppressing an increase in a processing time.

According to the present example embodiment, quality information includes resolution of the target image.

Thereby, processing in the neural network NN1 can be changed according to resolution of the target image. Therefore, it becomes possible to perform recognition regardless of quality of the target image while suppressing an increase in a processing time.

According to the present example embodiment, the information processing system 100 further includes the policy determination unit 112 that determines a network policy based on quality information.

Thereby, a network policy according to quality of a target image can be determined. Then, processing in the neural network NN1 can be changed according to the determined network policy. Therefore, it becomes possible to perform recognition regardless of the quality of the target image while suppressing an increase in a processing time.

According to the present example embodiment, the policy determination unit 112 determines a network policy in such a way that a time of processing using the neural network NN1 falls within a previously determined range, regardless of resolution of a target image.

Thereby, while changing processing in the neural network NN1 according to the resolution of the target image, an increase in the processing time due to the change in processing can be suppressed. Therefore, it becomes possible to perform recognition regardless of quality of the target image, while suppressing an increase in a processing time.

According to the present example embodiment, the neural network NN1 is made up of the front-stage group FNN2 including the input layer INL and the rear-stage group RNN including the final layer OUTL. The network policy is applied to image processing using the front-stage group FNN2.

Thereby, processing in the neural network NN1 can be changed according to resolution of a target image. Moreover, an increase in a processing time can be suppressed, rather than improving, by use of an image super-resolution technique or the like, quality of an input image input to the neural network NN1. Therefore, it becomes possible to perform recognition regardless of quality of the target image while suppressing an increase in a processing time.

### Second Example Embodiment

In the present example embodiment, a detailed example of a network policy and processing executed by an image processing unit 113 is described. In the present example embodiment, in order to simplify description, description overlapping with the example embodiment described above is omitted as appropriate.

It is preferable that an information processing system according to the present example embodiment is configured substantially similar to the information processing system 100 according to the first example embodiment illustrated in FIGS. 4 and 6. That is to say, for example, the image processing unit 113 processes a target image by use of a neural network according to a network policy, similar to the first example embodiment. Moreover, for example, the neural network configuring the image processing unit 113 performs an arithmetic operation by use of more detailed information according to the network policy as quality of the target image is lower, similar to the first example embodiment.

The image processing unit 113 according to the present example embodiment converts an iris region included in the target image into a standard image with a previously determined shape, and processes the converted standard image as an input image to the neural network.

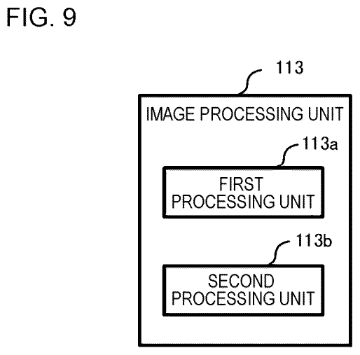

FIG. 9 is a diagram illustrating a functional configuration example of the image processing unit 113 according to a second example embodiment. The image processing unit 113 includes a first processing unit 113a and a second processing unit 113b.

The first processing unit 113a converts a target region (i.e., for example, an iris region) included in a target image into a standard image with a previously determined shape. Specifically, for example, the first processing unit 113a extracts an iris region from the target image, and converts the extracted iris region into a standard image with a previously determined shape. In this way, the first processing unit 113a generates a standard image, based on the target image.

The second processing unit 113b processes the standard image acquired by the first processing unit 113a, by use of a neural network according to a network policy determined by a policy determination unit 112. In processing of the standard image, the second processing unit 113b according to the present example embodiment extracts a feature vector from, for example, a standard image.

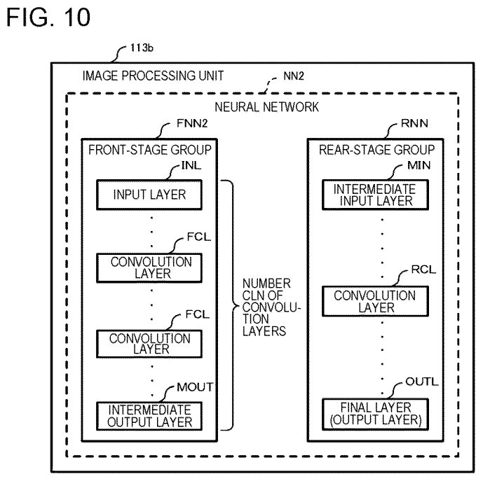

FIG. 10 is a diagram illustrating a configuration example of a neural network NN2 according to the second example embodiment. The neural network NN2 is used for processing of a standard image performed by the second processing unit 113b according to the second example embodiment. The present example embodiment is also described by use of an example in which the neural network NN2 is a convolution neural network.

The neural network NN2 includes, for example, a plurality of layers, similar to the first example embodiment. The plurality of layers included in the neural network NN2 are made up of a front-stage group FNN2 including an input layer INL, and a rear-stage group RNN similar to that according to the first example embodiment.

The front-stage group FNN2 includes an input layer INL, CLN convolution layers FCL, and an intermediate output layer MOUT.

Similar to the first example embodiment, the input layer INL acquires an input image, and propagates the input image to, for example, a subsequent layer. The input image according to the present example embodiment is a standard image generated by the first processing unit 113a.

Each layer including the CLN convolution layers FCL processes the input image, and extracts, for example, a feature vector of the input image. The intermediate output layer MOUT outputs a processing result in the neural network NN2 as an intermediate feature vector. Note that, the intermediate output layer MOUT may be a convolution layer.

In the present example embodiment as well, the network policy determined by the policy determination unit 112 is applied to image processing using the front-stage group FNN2.

Specifically, for example, the policy determination unit 112 according to the present example embodiment determines a network policy in such a way that the number CLN of the convolution layers FCL included in the front-stage group FNN2 is larger as resolution of the target image is lower. The network policy is one example of a network policy in which the front-stage group FNN2 performs an arithmetic operation by use of more detailed information as quality of the target image is lower.

It is preferable that information processing according to the present example embodiment is configured substantially similar to information processing according to the first example embodiment illustrated in FIG. 7. That is to say, for example, in step S105, the image processing unit 113 processes a target image by use of a neural network according to a network policy determined based on quality information of the target image.

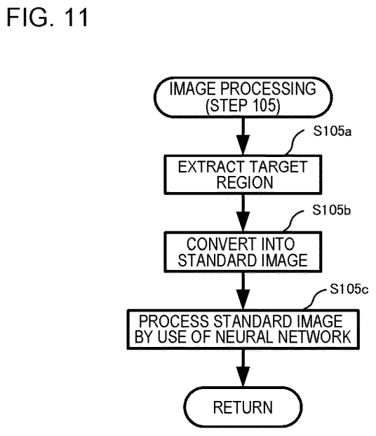

FIG. 11 is a flowchart illustrating a detailed example of image processing (step S105) according to the second example embodiment. Note that, in the image processing (step S105), as described with reference to FIG. 7, it is preferable that the image processing unit 113 processes a target image by use of a neural network according to the network policy determined in step S104.

The first processing unit 113a extracts a target region from the target image (step S105a).

Specifically, for example, the target region is an iris region. Thus, the first processing unit 113a extracts a substantially ring-shaped iris region.

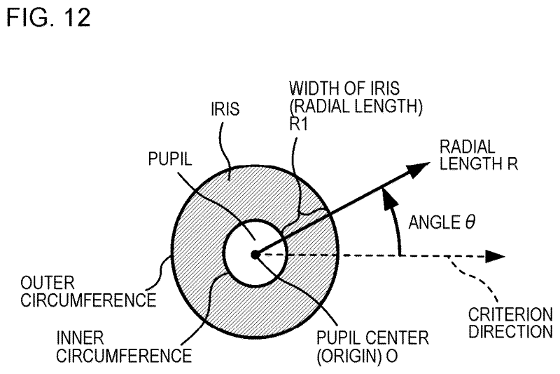

FIG. 12 is a diagram illustrating one example of an iris region according to the second example embodiment. In the figure, an iris region is a hatched region, and is surrounded by inner and outer circumferences being concentric circles centered on a pupil center O. The inner circumference is a circumference according to a pupil diameter. The outer circumference is a circumference according to an iris diameter. Such an iris region can be represented, for example, in a polar coordinate system designating the pupil center O as an origin and using a radial length R, and an angle θ making a predetermined criterion direction. Note that, inside of the inner circumference is a region being relevant to a pupil, but the region may not be included in the iris region.

FIG. 11 is referred to again.

The first processing unit 113a converts the target region extracted in step S105a into a standard image with a previously determined shape (step S105b). Thereby, the first processing unit 113a generates a standard image.

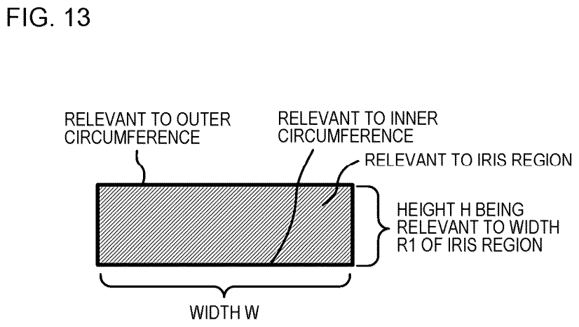

FIG. 13 is a diagram illustrating one example of a standard image according to the second example embodiment. Although the figure illustrates an example in which a previously determined shape is a rectangle, a previously determined shape is not limited thereto.

In a case where a ring-shaped iris region illustrated in FIG. 12 is converted into a rectangular standard image illustrated in FIG. 13, for example, height H of the standard image is relevant to a width R1 of the ring-shaped iris region. Moreover, for example, the width W of the standard image is relevant to outside and inside of the ring-shaped iris region.

It is preferable that, in step S105b, the first processing unit 113a converts the iris region into a standard image with a size according to quality information (e.g., resolution) of the iris region. That is to say, the size of the standard image may differ according to quality (e.g., an image size of the iris region) of the target image. In this case, it is preferable that, as quality of the target image is higher (e.g., as an image size of the iris region is larger), the first processing unit 113a converts the target region into a standard image with a larger size. Moreover, in a case where the standard image is rectangular, an aspect ratio thereof may be constant.

An appropriate method may be adopted for a method of converting the ring-shaped iris region into a rectangular standard image.

For example, the first processing unit 113a may convert the target region into a standard image with a discretely different size according to quality of the target image. In this case, for example, it is preferable that the first processing unit 113a previously holds conversion pattern data indicating sizes of a plurality of standard images according to quality of the target image. Then, it is preferable that the first processing unit 113a acquires, from the conversion pattern data, a size of the standard image being relevant to the quality of the target region estimated in step S103, and converts the target region extracted in step S105a into a standard image with the acquired size. It is preferable that such conversion is performed as appropriate by use of conversion from a polar coordinate system into an orthogonal coordinate system, conversion of upsampling and downsampling a number of image pixels, or the like.

Moreover, for example, the first processing unit 113a may convert a target region into standard images of successively different sizes according to quality of the target image. In this case, for example, it is preferable that the first processing unit 113a converts the iris region extracted in step S105a into a rectangular image, by use of conversion from a polar coordinate system to an orthogonal coordinate system. Then, in a case where an aspect ratio of the rectangular image differs from an aspect ratio of a predetermined standard image, the first processing unit 113a may convert the rectangular image into a standard image with a previously determined aspect ratio by use of at least one of conversions of upsampling and downsampling a number of image pixels.

In this instance, in order to convert the aspect ratio of the rectangular image into the previously determined aspect ratio of the standard image, it is preferable to determine, in accordance with a previously determined conversion condition, how much each of vertical and horizontal directions is converted.

For example, in a case where the conversion condition is not to convert the horizontal direction, it is preferable that the first processing unit 113a converts the rectangular image into a standard image being a rectangle with a previously determined aspect ratio, by downsampling a number of image pixels in the vertical direction. Moreover, for example, in a case where the conversion condition is not to convert the vertical direction, it is preferable that the first processing unit 113a converts the rectangular image into a standard image being a rectangle with a previously determined aspect ratio, by upsampling or downsampling a number of image pixels in the horizontal direction. Note that, the conversion condition is not limited to thereto.

By converting in this way, an iris region can be converted into a standard image with a size according to quality information (e.g., resolution) of the iris region. Moreover, a standard image becomes an image with quality (e.g., resolution) being relevant to quality information of the iris region.

FIG. 11 is referred to again.

The second processing unit 113b processes the standard image generated in step S105b, by use of the neural network NN2 according to the network policy determined in step S104 (step S105c). Then, it is preferable that the second processing unit 113b returns to the information processing illustrated in FIG. 7.

Specifically, for example, a size of the standard image differs discretely or continuously according to quality of a target image, as described above. An example of a network policy is described regarding each case.

### (Example of a Network Policy in a Case Where a Size of a Standard Image Differs Discretely)

For example, it is assumed that quality of a target image is resolution of the input image. Moreover, it is assumed that, in a case where resolution of an input image is previously determined criterion resolution, the number CLN of the convolution layers FCL used in an arithmetic operation in the front-stage group FNN2 is a criterion value RFN1.

In this case, the policy determination unit 112 may determine a network policy of increasing the number CLN of the convolution layers FCL used for an arithmetic operation in the front-stage group FNN to RFN1*N*N in a case where resolution of the input image becomes 1/N with respect to the criterion resolution. Each of N and RFN1 is an integer equal to or more than 1. Moreover, “*” represents multiplication.

Thereby, the second processing unit 113b processes the input image by use of the front-stage group FNN2 including the number CLN of the convolution layers FCL according to the network policy, and outputs an intermediate feature vector.

Note that, the network policy is not limited thereto, and, for example, how detailed information to be used in an arithmetic operation and the like may be changed as appropriate according to quality of a target image.

### (Example of a Network Policy in a Case Where a Size of a Standard Image Differs Continuously)

For example, similar to a case where a size differs discretely, it is assumed that quality of a target image is resolution of an input image. Moreover, in a case where resolution of an input image is previously determined criterion resolution, it is assumed that the number CLN of the convolution layers FCL used in an arithmetic operation in the front-stage group FNN2 is the criterion value RFN1.

In this case, the policy determination unit 112 may determine a network policy of increasing the number CLN of the convolution layers FCL used for an arithmetic operation in the front-stage group FNN to [RFN1*α*α] in a case where resolution of an input image becomes 1/α with respect to the criterion resolution. Herein, α is a real number, and satisfies, for example, 0<α≤1. Moreover, the symbol [X] is a Gaussian function (also referred to as a floor function), and represents the maximum integer that does not exceed the real number X within the symbol. That is to say, [RFN1*α*α] represents the maximum integer that does not exceed RFN1*α*α.

Thereby, the second processing unit 113b processes the input image by use of a front-stage group FNN2 including the number CLN of the convolution layers FCL according to the network policy, and outputs an intermediate feature vector. Note that, the network policy is not limited thereto, and, for example, how detailed information to be used in an arithmetic operation and the like may be changed as appropriate according to quality of a target image, which is similar to a case where a size of a standard image differs discretely.

Moreover, in a case where a size of a standard image differs continuously, it is preferable that the front-stage group FNN2 adjusts a map shape of an intermediate feature vector in such a way that the intermediate feature vector has a shape (i.e., a size) of a feature vector map that can be input to the rear-stage group RNN.

For example, interpolation can be used as a method for adjusting a map shape of an intermediate feature vector. For example, it is assumed that a convolution arithmetic operation with a slide S and a padding PD is performed by use of a 3×3 filter, and a shape of the feature vector map input thereto is (Hin, Win). In a case where a shape of a feature vector map output by the convolution operation is (Hout, Wout), it is preferable that a feature vector map to be input is adjusted by use of interpolation in such a way as to satisfy relationships of Hin=S*(Hout−1)+3−2*PD and Win=S*(out−1)+3−2*PD. For the interpolation, it is preferable to use a nearest neighbor method, linear interpolation, a bilinear method, a bicubic method, or the like. It is preferable that such interpolation is performed, for example, before the first convolution layer FCL (i.e., the convolution layer FCL closest to input) included in the front-stage group FNN2.

Moreover, for example, a value of a dilation parameter used in the convolution layer FCL can be used as a method for adjusting a map shape of an intermediate feature vector. The dilation parameter is a parameter for adjusting an interval of values on a map with which a product with a filter used in the convolution layer FCL is taken.

Note that, a method for adjusting a map shape of an intermediate feature vector is not limited to thereto.

### (Action and Effect)

As described above, according to the present example embodiment, the image processing unit 113 includes the first processing unit 113a and the second processing unit 113b.

The first processing unit 113a converts an iris region included in a target image into a standard image with a previously determined shape. The second processing unit 113b processes the standard image by use of the neural network NN2 according to a network policy. The first processing unit 113a converts the iris region into a standard image with a size according to quality information.

Thereby, since a shape of an input image to the neural network NN2 can be standardized to a previously determined shape, processing in the neural network NN2 can be performed more easily than in a case where a shape of the input image is indefinite.

Moreover, since an image being relevant to an iris region can be used for an input image, a feature vector of the iris region can be accurately extracted, and recognition performance of iris recognition can be improved.

Further, generally, in a case where resolution of an image is improved by use of an image super-resolution technique or the like, a neural network processes a high-resolution image, and, therefore, a processing time in the neural network often becomes long. In the present example embodiment, since a standard image has a size according to resolution, an increase in a processing time in the neural network NN2 can be suppressed compared to uniformly processing a high-resolution image in the neural network NN2.

Therefore, it becomes possible to accurately perform recognition regardless of quality of a target image while suppressing an increase in a processing time.

According to the present example embodiment, the neural network NN2 includes a plurality of convolution layers FCL and RCL. The policy determination unit 112 determines a network policy in such a way that the number CLN of the convolution layers FCL included in the front-stage group FNN2 is larger as resolution of a target image is lower.

Thereby, since the more convolution layers FCL can be used as quality of a target image is lower, an arithmetic operation using detailed information can be performed. Thus, an input image can be processed in the neural network NN2 in such a way that recognition can be accurately performed regardless of quality of the input image. Moreover, an increase in a processing time can be suppressed compared to improving quality of an input image input to the neural network NN2 by use of image super-resolution technique or the like.

Therefore, it becomes possible to perform recognition regardless of quality of a target image while suppressing an increase in a processing time.

### Third Example Embodiment

In the second example embodiment, an example in which the number CLN of the convolution layers FCL is larger as resolution of a target image is lower, and, thereby, an arithmetic operation is performed by use of more detailed information as quality of the target image is lower has been described. In a third example embodiment, as another example in which an arithmetic operation is performed by use of more detailed information as quality of a target image is lower, an example in which the number of channels in an arithmetic operation in a convolution layer FCL is increased as resolution of the target image is lower is described. In the present example embodiment, in order to simplify description, description overlapping with the example embodiment described above is omitted as appropriate.

In the present example embodiment, a configuration of a neural network used in processing of a standard image performed by a second processing unit 113b is different from that according to the second example embodiment. Except for this point, an information processing system according to the present example embodiment is configured substantially similar to the information processing system according to second example embodiment.

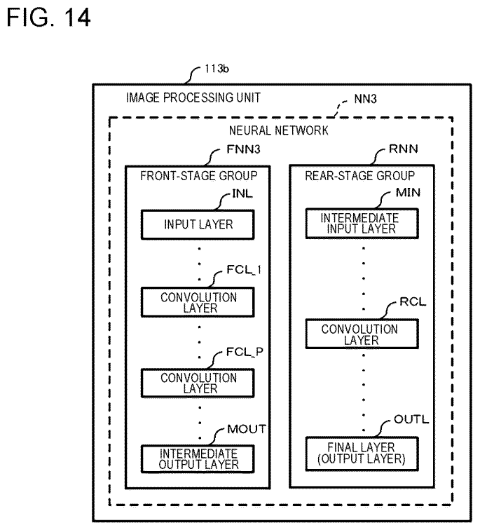

FIG. 14 is a diagram illustrating a configuration example of a neural network NN3 according to the third example embodiment. The neural network NN3 is used for processing of a standard image performed by the second processing unit 113b according to the third example embodiment. The present example embodiment is also described by use of an example in which the neural network NN3 is a convolution neural network.

The neural network NN3 includes, for example, a plurality of layers, similar to the first example embodiment. The plurality of layers included in the neural network NN3 are made up of a front-stage group FNN2 including an input layer INL, and a rear-stage group RNN similar to that according to the first example embodiment.

The front-stage group FNN3 includes an input layer INL similar to that according to the first example embodiment, P convolution layers FCL_1 to FCL_P, and an intermediate output layer MOUT. Herein, P is an integer equal to or more than 2.

The convolution layers FCL_1 to FCL_P are different from each other in the number of channels. The number of channels is equivalent to, for example, the number of filters used in each of the convolution layers FCL_1 to FCL_P. Each layer including one of the convolution layers FCL_1 to FCL_P processes an input image, and extracts, for example, a feature vector of the input image. Note that, the present example embodiment is described by use of an example in which the number of the convolution layers FCL with the same number of channels is one, but the front-stage group FNN3 may include a plurality of convolution layers FCL with the same number of channels.

The intermediate output layer MOUT outputs a processing result in the neural network NN2 as an intermediate feature vector.

In the present example embodiment, since the numbers of channels of the convolution layers FCL_1 to FCL_P are different, a shape of a feature vector map output from each of the convolution layers FCL_1 to FCL_P is different. The intermediate output layer MOUT may adjust a size of the intermediate feature vector (a shape of the feature vector map indicating the intermediate feature vector) in such a way that the intermediate feature vector can be input to the rear-stage group RNN no matter which of the convolution layers FCL_1 to FCL_P is used. For example, it is preferable to use 1×1 convolution or the like for the adjustment.

In the present example embodiment as well, a network policy determined by a policy determination unit 112 is applied to image processing using the front-stage group FNN3.

Specifically, for example, the policy determination unit 112 according to the present example embodiment determines a network policy in such a way as to use the more convolution layers FCL with a larger number of channels in the front-stage group FNN2 as resolution of a target image is lower. The network policy is one example of a network policy in which the front-stage group FNN3 performs an arithmetic operation by use of more detailed information as quality of the target image is lower.

It is preferable that information processing according to the present example embodiment is configured substantially similar to information processing according to the first example embodiment illustrated in FIG. 7. Moreover, details of image processing (step S105) according to the present example embodiment are configured substantially similar to those of image processing (step S105) according to the second example embodiment illustrated in FIG. 11.

That is to say, for example, in step S105c, the second processing unit 113b processes a standard image generated in step S105b by use of the neural network NN3 according to the network policy determined in step S104.

For example, it is assumed that a size of a standard image differs discretely, and quality of a target image is resolution of an input image. Moreover, it is assumed that, in a case where resolution of an input image is previously determined criterion resolution, the number of channels of the convolution layers FCL_1 to FCL_P used for an arithmetic operation in the front-stage group FNN2 is a criterion value RFN2. Herein, RFN2 is an integer equal to or more than 1.

In this case, the policy determination unit 112 may determine a network policy of increasing the number of channels of the convolution layers FCL_1 to FCL_P used for an arithmetic operation in the front-stage group FNN to RFN2*N*N in a case where resolution of an input image becomes 1/N with respect to the criterion resolution.

Thereby, the second processing unit 113b processes the input image by use of the front-stage group FNN3 including the convolution layer FCL with the number of channels according to the network policy among the convolution layers FCL_1 to FCL_P, and outputs an intermediate feature vector. Note that, the network policy is not limited thereto, and, for example, how detailed information to be used to perform an arithmetic operation and the like may be changed as appropriate according to quality of a target image.

For example, a network policy may be determined in which, in a case where a size of a standard image changes continuously, the number of channels of the convolution layers FCL_1 to FCL_P used for an arithmetic operation in the front-stage group FNN is increased to [RFN2*α*α] once resolution of an input image becomes 1/α of criterion resolution. A symbol [ ] herein is a Gaussian function similar to that described above. That is to say, [RFN2*α*α] represents the maximum integer that does not exceed RFN2*α*α.

Note that, the network policy is not limited thereto, and, for example, how detailed information to be used in an arithmetic operation and the like may be changed as appropriate according to quality of a target image, which is similar to a case where a size of a standard image differs discretely.

Moreover, in a case where a size of a standard image differs continuously, it is preferable that the front-stage group FNN3 adjusts a map shape of an intermediate feature v vector value in such a way that the intermediate feature vector can be input to the rear-stage group RNN, similar to the second example embodiment.

### (Action and Effect)

As described above, according to the present example embodiment, the neural network NN3 includes the plurality of convolution layers FCL_1 to FCL_P and RCL. The policy determination unit 112 determines a network policy in such a way that the number of channels in an arithmetic operation in the convolution layers FCL_1 to FCL_P included in the front-stage group FNN3 is larger as resolution of a target image is lower.

In this way, since the convolution layers FCL_1 to FCL_P with a larger number of channels can be used as quality of a target image is lower, an arithmetic operation using detailed information can be performed. Thus, an input image can be processed in the neural network NN3 in such a way that recognition can be accurately performed regardless of quality of the input image. Moreover, an increase in a processing time can be suppressed compared to improving quality of an input image input to the neural network NN3 by use of image super-resolution technique or the like.

Therefore, it becomes possible to perform recognition regardless of quality of a target image while suppressing an increase in a processing time.

### Fourth Example Embodiment

In a fourth example embodiment, an example of a training method for neural networks NN1 to NN3 is described. In the present example embodiment, a training method for the neural network NN1 according to the first example embodiment is described as an example. Moreover, in the present example embodiment, in order to simplify description, description overlapping with the example embodiment described above is omitted as appropriate.

### (Configuration Example of an Information Processing System 400 According to a Fourth Example Embodiment)

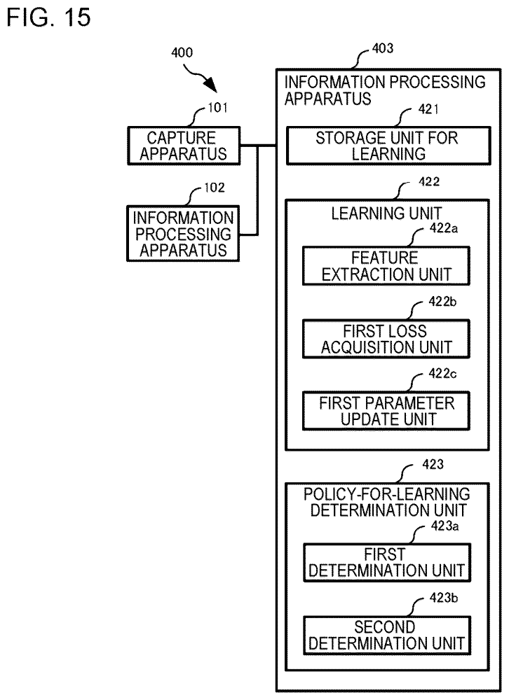

FIG. 15 is a diagram illustrating a configuration example of the information processing system 400 according to the fourth example embodiment. The information processing system 400 includes an information processing apparatus 403 in addition to a capture apparatus 101 and an information processing apparatus 102 similar to those according to the first example embodiment.

The information processing apparatus 403 is an apparatus for performing training of the neural network NN1. The information processing apparatus 403 includes a storage unit for training 421, a training unit 422, and a policy-for-training determination unit 423.

The storage unit for training 421 is a storage unit for previously storing data for training. The data for training include a target image for training and a correct answer value. For example, in a case where a feature vector of a target image is extracted by use of the neural network NN1, the correct answer value is a feature vector of the target image for training.

The target image for training is an image for training. Similar to the target image, the target image for training may be an image including a target region, and is, for example, an eye image.

Note that, the storage unit for training 421 may previously store data for training including a plurality of different target images for training. In this case, it is desirable that the plurality of target images for training include target images for training different in quality.

The training unit 422 performs training of the neural network NN1 by inputting the target image for training to the neural network NN1.

Specifically, for example, the training unit 422 includes a feature extraction unit 422a, a first loss acquisition unit 422b, and a first parameter update unit 422c.

The feature extraction unit 422a extracts a feature vector of the target image for training by use of the neural network NN1 according to a network policy.

The first loss acquisition unit 422b derives a first loss function by deriving an error (first loss) between the extracted feature vector and the correct answer value of the target image for training.

The first parameter update unit 422c derives a gradient, based on a first loss function, and updates a parameter included in the neural network NN1.

The policy-for-training determination unit 423 determines a network policy regarding the target image for training, based on quality information of the target image for training and a probability distribution for training.

Specifically, for example, the policy-for-training determination unit 423 includes a first determination unit 423a and a second determination unit 423b.

The first determination unit 423a changes quality information of the target image for training in accordance with the probability distribution for training by using a random number, and determines quality information for training.

More specifically, for example, it is preferable that the first determination unit 423a has a function similar to that of a quality estimation unit 111. That is to say, it is preferable that the first determination unit 423a estimates a target region position in a target image for training, and estimates quality of the target image for training.

Then, the first determination unit 423a changes the quality estimated regarding the target image for training, in accordance with the probability distribution for training by using a random number, and determines quality information for training. The probability distribution for training is, for example, a probability distribution being highest in probability with quality indicated by quality information of the target image for training, and becoming gradually lower in probability as a degree of being different from the quality becomes larger.

The second determination unit 423b determines a network policy regarding the target image for training according to the quality information for training determined by the first determination unit 423a.

It is preferable that the information processing apparatus 403 is physically configured similar to the information processing apparatus 102 (refer to FIG. 6). However, the storage device 1040 of the information processing apparatus 403 stores a program module for achieving a function of the information processing apparatus 403. Moreover, a network interface 1050 of the information processing apparatus 403 is an interface for connecting the information processing apparatus 403 to a network.

### (Operation Example of the Information Processing System 400 According to the Fourth Example Embodiment)

The information processing system 400 executes information processing. The information processing according to the present example embodiment includes training processing in addition to processing similar to that according to the first example embodiment. The training processing is, for example, processing for performing training of the neural network NN1. For example, the information processing apparatus 403 starts the training processing once an instruction of a user is accepted.

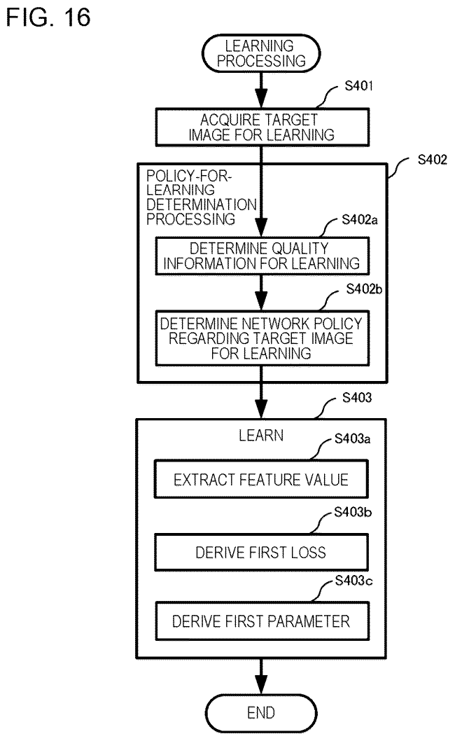

FIG. 16 is a flowchart illustrating one example of training processing according to the fourth example embodiment.

The policy-for-training determination unit 423 acquires a target image for training from the storage unit for training 421 (step S401).

Note that, the policy-for-training determination unit 423 may acquire a target image for training from another information processing apparatus (not illustrated) via a network or the like, or may acquire the target image for training via a storage medium.

The policy-for-training determination unit 423 determines a network policy regarding the target image for training acquired in step S401, based on quality information of the target image for training and a probability distribution for training (step S402).

Specifically, for example, the first determination unit 423a changes the quality information of the target image for training according to the probability distribution for training, and determines quality information for training (step S402a).

More specifically, for example, the first determination unit 423a estimates quality of the target image for training. Note that, quality of the target image for training may be previously stored in the storage unit for training 421 in association with the target image for training. In this case, the first determination unit 423a may not estimate quality of the target image for training.

The first determination unit 423a changes the quality estimated regarding the target image for training in accordance with the probability distribution for training, and determines quality information for training.

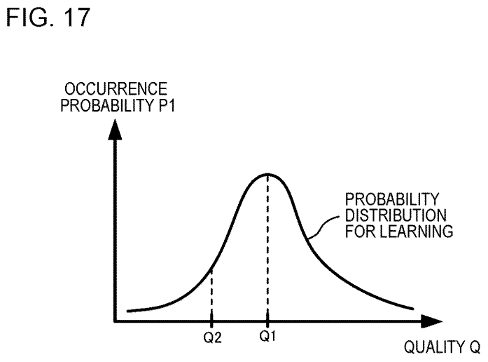

FIG. 17 is a diagram illustrating one example of a probability distribution for training according to the fourth example embodiment. A horizontal axis in the figure indicates quality Q. A vertical axis in the figure indicates an occurrence probability P1.

Q1 in the figure is quality indicated by quality information of a target image for training. The probability distribution for training illustrated in the figure is a probability distribution in which the quality Q1 indicated by the quality information of the target image for training appears with the highest probability, and appears with gradually lower probability as a degree of being different from that quality becomes larger. Moreover, the probability distribution for training illustrated in the figure is an example of a probability distribution being symmetrical via the quality Q1 of the target image for training.

The first determination unit 423a changes the quality Q1 of the target image for training by generating a random number in accordance with such a probability distribution for training. Q2 in the figure is, for example, an example of quality for training acquired based on the quality Q1 of the target image for training and the random number generated in accordance with the probability distribution for training. In this case, the first determination unit 423a changes the quality Q1 of the target image, and determines quality information for training including the quality for training Q2.

Note that, the probability distribution for training is not limited to the probability distribution illustrated in FIG. 17. For example, generally, it is often difficult to accurately authenticate by use of a target image as quality of the target image is lower. Thus, the probability distribution for training may be a probability distribution in which low quality being lower than the quality Q1 of the target image for training has a higher probability than a high quality being higher than the quality Q1 of the target image for training. Moreover, for example, the probability distribution for training may be a probability distribution in which high quality has a higher probability than low quality than the quality Q1. Further, the policy-for-training determination unit 423 may determine a plurality of network policies regarding one target image for training.

FIG. 16 is referred to again.

The second determination unit 423b determines a network policy regarding the target image for training according to the quality information for training determined in step S402a (step S402b).

Specifically, for example, it is preferable that the second determination unit 423b determines, as the network policy regarding the target image for training, a network policy according to the quality information for training determined in step S402a.

The training unit 422 inputs the target image for training acquired in step S401 to the neural network NN1 according to the network policy determined in step S402b. Thereby, the training unit 422 performs training of the neural network NN1 (step S403), and ends the training processing.

In training in the training unit 422, it is preferable to use a general technique of machine training. For example, the training unit 422 (feature extraction unit 422a) extracts a feature vector of the target image for training by use of the neural network NN1 according to a network policy (step S403a). Thereby, it is preferable that the training unit 422 estimates a feature vector of the target image for training by use of the neural network NN1 according to the network policy.

Then, the training unit 422 (first loss acquisition unit 422b) derives, for example, an error (first loss) between the feature vector extracted in step S403a and a correct answer value of the target image for training (step S403b). Thereby, it is preferable that the training unit 422 derives a first loss function for computing an error (loss) between the estimated feature vector and the correct answer value of the target image for training. For example, it is preferable that cross entropy (error), a mean squared error, a mean absolute error (MAE), or the like is used as the loss.

It is preferable that the training unit 422 (first parameter update unit 422c) derives a gradient based on a first loss function, and derives a first parameter to be used for update of a parameter included in the neural network NN1. Then, it is preferable that the training unit 422 (first parameter update unit 422c) may update the parameter included in the neural network NN1 by use of the first parameter (step S403c).

Note that, the policy-for-training determination unit 423 may acquire a plurality of target images for training in step S401. In this case, it is preferable that the policy-for-training determination unit 423 and the training unit 422 execute steps S402 and S403 regarding each of the target images for training.

### (Action and Effect)

As described above, according to the present example embodiment, the information processing system 400 further includes a training unit 422 that performs training of the neural network NN1 by inputting a target image for training to the neural network NN1.

Thereby, training of the neural network NN1 can be performed.

According to the present example embodiment, the information processing system 400 further includes a policy-for-training determination unit 423 that determines a network policy regarding the target image for training, based on quality information of the target image for training and a probability distribution for training. The training unit 422 performs training of the neural network NN1 by inputting a target image for training to the neural network NN1 according to the determined network policy. The probability distribution for training is a probability distribution being highest in probability with quality indicated by quality information of the target image for training, and becoming gradually lower in probability as a degree of being different from the quality becomes larger.

Generally, there is a possibility that the quality estimation unit 111 erroneously estimates quality of a target image. According to the present example embodiment, training of the neural network NN1 being relevant to quality for training mainly including quality of the target image for training and quality of a periphery thereof can be performed based on the target image for training. Thereby, training for such image processing (e.g., extraction of a feature vector using the neural network NN1) that recognition can be accurately performed even in a case where quality of a target image is erroneously estimated can be performed. Therefore, it becomes possible to accurately perform recognition regardless of quality of a target image.

According to the present example embodiment, the policy-for-training determination unit 423 includes the first determination unit 423a and the second determination unit 423b. The first determination unit 423a changes quality information of a target image for training in accordance with the probability distribution for training by using a random number, and determines quality information for training. The second determination unit 423b determines a network policy regarding the target image for training according to the determined quality information for training.

Thereby, training of the neural network NN1 being relevant to quality for training mainly including quality of the target image for training and quality of a periphery thereof can be performed based on the target image for training. Thus, as described above, it becomes possible to accurately perform recognition regardless of quality of a target image.

### Fifth Example Embodiment

In a fifth example embodiment, another example of a training method of the neural networks NN1 to NN3 is described. In the present example embodiment, the training method of the neural network NN1 according to the first example embodiment is described as an example. Moreover, in the present example embodiment, in order to simplify description, description overlapping with the example embodiment described above is omitted as appropriate.

### (Configuration Example of an Information Processing System 500 According to the Fifth Example Embodiment)

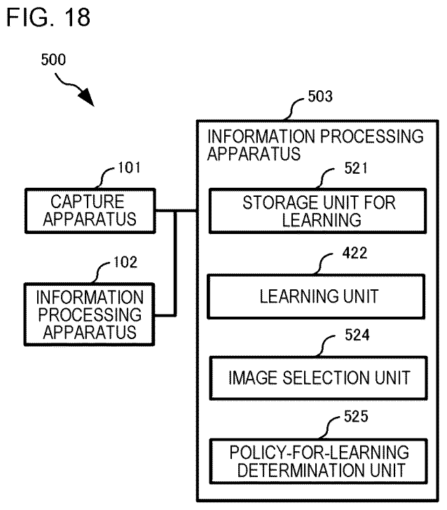

FIG. 18 is a diagram illustrating a configuration example of an information processing system 500 according to the fifth example embodiment. The information processing system 500 includes an information processing apparatus 503 in addition to a capture apparatus 101 and an information processing apparatus 102 similar to those according to the first example embodiment.

The information processing apparatus 503 is an apparatus for performing training of a neural network NN1. The information processing apparatus 503 includes a training unit 422 being substantially similar to that according to the fourth example embodiment, a storage unit for training 521, an image selection unit 524, and a policy-for-training determination unit 525.

The storage unit for training 521 is a storage unit for previously storing data for training. The data for training according to the present example embodiment may associate each of a plurality of target images for training with each correct answer value. It is preferable that the plurality of target images for training may include target images for training being different in quality. Further, the data for training according to the present example embodiment may be further associated with the quality of each target image for training.

The training unit 422 performs training of the neural network NN1 by inputting a target image for training selected by the image selection unit 524 (described in detail later) to the neural network NN1.

The image selection unit 524 selects the target image for training in such a way that more target images for training with lower quality are selected. For example, the image selection unit 524 selects a target image for training in such a way that more low-resolution target images for training are selected than high-resolution target images for training.

The policy-for-training determination unit 525 determines, based on quality information of the target images for training selected by the image selection unit 524, a network policy of the target image for training selected by the image selection unit 524. It is preferable that the policy-for-training determination unit 525 determines a network policy of a target image for training selected by the image selection unit 524 by use of processing similar processing for the policy determination unit 112 to determine a network policy.

It is preferable that the information processing apparatus 503 is physically configured similar to the information processing apparatus 102 (refer to FIG. 6). However, a storage device 1040 of the information processing apparatus 503 stores a program module for achieving a function of the information processing apparatus 503. Moreover, the network interface 1050 of the information processing apparatus 503 is an interface for connecting the information processing apparatus 503 to a network.

### (Operation Example of the Information Processing System 500 According to the Fifth Example Embodiment)

The information processing system 500 executes information processing. The information processing according to the present example embodiment includes training processing in addition to processing similar to that according to the first example embodiment. The training processing is, for example, processing for performing training of the neural network NN1, similar to the fourth example embodiment. For example, the information processing apparatus 503 starts the training processing once an instruction of a user is accepted.

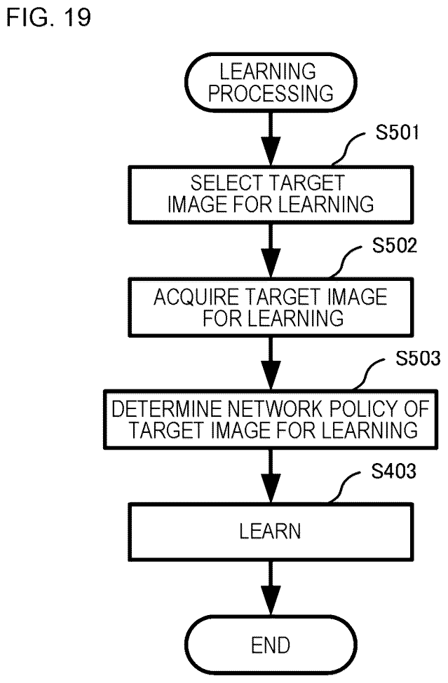

FIG. 19 is a flowchart illustrating one example of training processing according to the fifth example embodiment.

The image selection unit 524 selects a target image for training from among target images for training stored in the storage unit for training 521 in such a way that more target images for training with lower quality are selected (step S501).

Specifically, for example, it is preferable that the image selection unit 524 derives quality in accordance with a probability distribution for selection. The quality is, for example, resolution of an image.

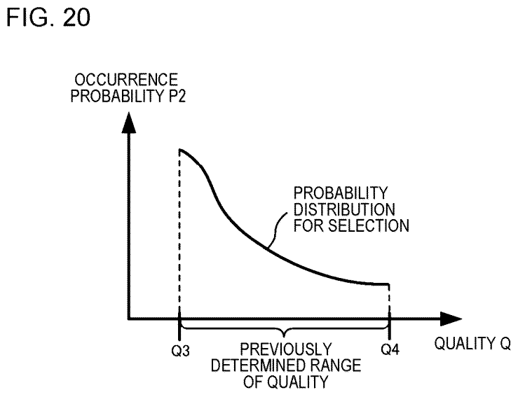

FIG. 20 is a diagram illustrating one example of a probability distribution for selection according to the fifth example embodiment. A horizontal axis in the figure indicates quality Q. A vertical axis in the figure indicates an occurrence probability P2. The probability distribution for selection is a probability distribution in which lower quality has a higher probability within a previously determined range of quality (a range from Q3 to Q4 in FIG. 20). Such a probability distribution for selection may be acquired, for example, by multiplying quality (e.g., resolution) by a previously determined weight.

Then, it is preferable that the image selection unit 524 selects a target image for training associated with the derived quality, from among target images for training stored in the storage unit for training 521.

Note that, in a case where data for training do not include quality, the image selection unit 524 may estimate a target region position in a target image for training, and estimate quality of the target image for training, for example, similar to the quality estimation unit 111. In this case, it is preferable that the image selection unit 524 selects, for example, a target image for training for which the same quality as quality derived in accordance with the probability distribution for selection has been estimated.

FIG. 19 is referred to again.

The image selection unit 524 acquires a target image for training selected in step S501, from, for example, the storage unit for training 421 (step S502).

The policy-for-training determination unit 525 determines a network policy regarding the target image for training acquired in step S502, based on quality information of the target image for training acquired in step S502 (step S503).

Specifically, for example, it is preferable that the policy-for-training determination unit 525 acquires, from the image selection unit 524, the quality information derived in step S501. Note that, the information processing apparatus 503 may further include a function similar to that of the quality estimation unit 111, and estimate, by use of the function, quality information of the target image for training acquired in step S502.

The training unit 422 performs training of the neural network NN1 (step S403), and ends the training processing, similar to the fourth example embodiment.

In step S403 according to the present example embodiment, the training unit 422 inputs the target image for training acquired in step S502 to the neural network NN1 according to the network policy determined in step S504. Thereby, the training unit 422 performs training of the neural network NN1.

### (Action and Effect)

As described above, according to the present example embodiment, the information processing system 500 further includes the image selection unit 524 that selects a target image for training in such a way that more target images for training with lower quality are selected. The training unit 422 performs training of the neural network NN1 by inputting the selected target image for training to the neural network NN1.

Generally, it is often difficult to accurately authenticate by use of a target image as quality of the target image is lower. According to the present example embodiment, since more target images for training with lower quality are selected, the neural network NN1 being compatible with low quality can perform more training. Thereby, training for such image processing (e.g., extraction of a feature vector using the neural network NN1) that recognition can be accurately performed even in a case where quality of a target image is low can be performed. Therefore, it becomes possible to accurately perform recognition regardless of quality of a target image.

### Sixth Example Embodiment

Training methods described in the fourth and fifth example embodiments may be combined. In the sixth example embodiment, as yet another example of the training method of neural networks NN1 to NN3, an example in which the training methods described in the fourth and the fifth example embodiments are combined is described. In the present example embodiment, a training method for the neural network NN1 according to the first example embodiment is described as an example. Moreover, in the present example embodiment, in order to simplify description, description overlapping with the example embodiment described above is omitted as appropriate.

### (Configuration Example of an Information Processing System 600 According to the Sixth Example Embodiment)

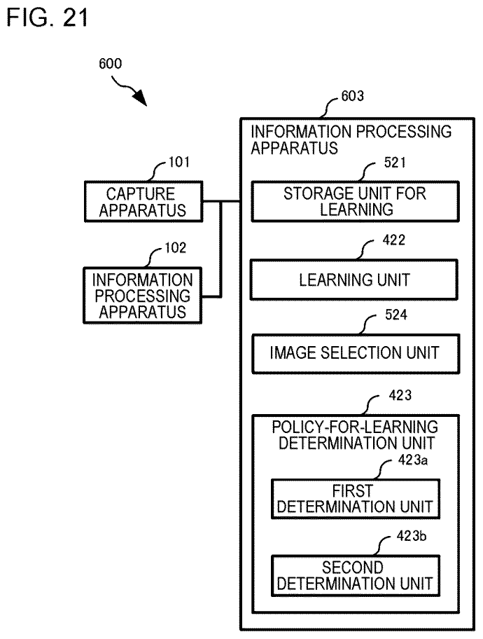

FIG. 21 is a diagram illustrating a configuration example of the information processing system 600 according to the sixth example embodiment. The information processing system 600 includes an information processing apparatus 603 in addition to a capture apparatus 101 and an information processing apparatus 102 similar to those according to the first example embodiment.

The information processing apparatus 603 is an apparatus for performing training of the neural network NN1. The information processing apparatus 603 includes a training unit 422 and a policy-for-training determination unit 423 that are substantially similar to those according to the fourth example embodiment, and a storage unit for training 521 and an image selection unit 524 that are substantially similar to those according to the fifth example embodiment.

The policy-for-training determination unit 423 according to the present example embodiment determines, based on quality information of a target image for training selected by the image selection unit 524 and a probability distribution for training, a network policy regarding the target image for training.

As described in the fourth example embodiment, it is preferable that the policy-for-training determination unit 423 includes a first determination unit 423a and a second determination unit 423b. That is to say, it is preferable that the first determination unit 423a changes quality information of a target image for training selected by the image selection unit 524, in accordance with the probability distribution for training by using a random number, and determines quality information for training. It is preferable that the second determination unit 423b determines a network policy regarding a target image for training according to the quality information for training determined by the first determination unit 423a.

The information processing apparatus 603 may be physically configured similar to the information processing apparatus 102 (refer to FIG. 6). However, a storage device 1040 of the information processing apparatus 603 stores a program module for achieving a function of the information processing apparatus 603. Moreover, a network interface 1050 of the information processing apparatus 603 is an interface for connecting the information processing apparatus 603 to a network.

### (Operation Example of an Information Processing System 600 According to the Sixth Example Embodiment)

The information processing system 600 executes information processing. The information processing according to the present example embodiment includes training processing in addition to processing similar to that according to the first example embodiment. The training processing is, for example, processing for performing training of the neural network NN1, similar to the fourth example embodiment. For example, the information processing apparatus 603 starts the training processing once an instruction of a user is accepted.

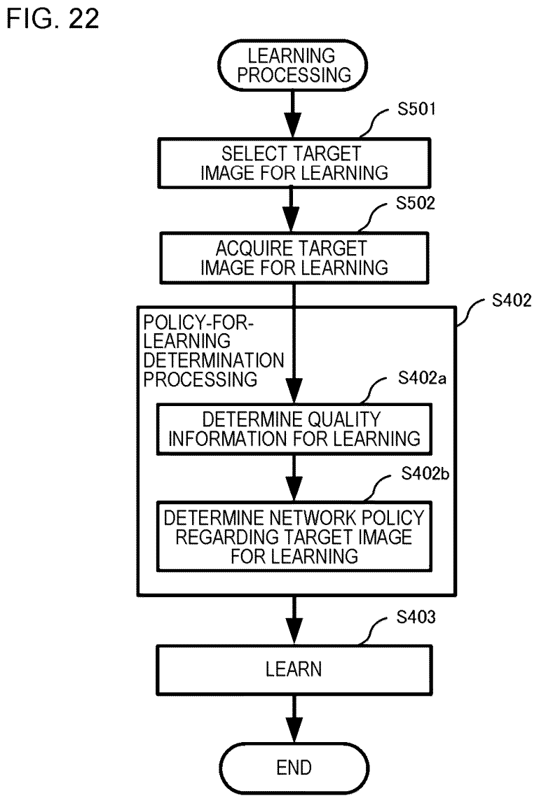

FIG. 22 is a flowchart illustrating one example of training processing according to the sixth example embodiment.

The image selection unit 524 executes steps S501 and S502 similar to those according to the fifth example embodiment.

The policy-for-training determination unit 423 executes a policy-for-training determination processing (step S402) being substantially similar to that according to the fourth example embodiment.

A target image for training to be a target of processing in step S402 according to the present example embodiment is, for example, a target image for training acquired in step S502. That is to say, in step S402 according to the present example embodiment, the policy-for-training determination unit 423 determines a network policy regarding the target image for training acquired in step S502.

Quality information of the target image for training used in step S402 according to the present example embodiment may be quality information derived in step S501. In this case, it is preferable that the policy-for-training determination unit 423 acquires quality information of the target image for training from the image selection unit 524. Note that, the information processing apparatus 603 may further include a function similar to that of the quality estimation unit 111, and estimate, by use of the function, quality information of the target image for training acquired in step S502. In this case, it is preferable that the estimated quality information is used in the processing in step S402 as quality of the target image for training.

The training unit 422 performs processing in step S403 being substantially similar to that according to the fourth example embodiment, and ends the training processing.

Specifically, for example, it is preferable that the training unit 422 inputs the target image for training acquired in step S502 to the neural network NN1 according to the network policy determined in step S402b. Thereby, it is preferable that the training unit 422 performs training of the neural network NN1.

### (Action and Effect)

As described above, according to the present example embodiment, the information processing system 600 includes the image selection unit 524, the policy-for-training determination unit 423, and the training unit 422.

The image selection unit 524 selects a target image for training in such a way that more target images for training with lower quality are selected.

The policy-for-training determination unit 423 determines a network policy regarding the target image for training, based on quality information of the target image for training and a probability distribution for training. The probability distribution for training is a probability distribution being highest in probability with quality indicated by quality information of the target image for training, and becoming gradually lower in probability as a degree of being different from the quality becomes larger.

The training unit 422 performs training of the neural network NN1 by inputting the selected target image for training to the neural network NN1 according to the determined network policy.

Thereby, as described in the fourth example embodiment, training for such image processing (e.g., extraction of a feature vector using the neural network NN1) that recognition can be accurately performed even in a case where quality of a target image is erroneously estimated can be performed. Moreover, as described in the fifth example embodiment, training for such image processing (e.g., extraction of a feature vector using the neural network NN1) that recognition can be accurately performed even in a case where quality of a target image is low can be performed. Therefore, it becomes possible to more accurately perform recognition regardless of quality of a target image.

### Seventh Example Embodiment

A network policy may be determined by use of a policy determination model. In the present example embodiment, an example in which a policy determination model is a first policy determination model configured by use of a neural network is described. In the present example embodiment, in order to simplify description, description overlapping with the example embodiment described above is omitted as appropriate.

### (Configuration Example of an Information Processing System 700 According to the Seventh Example Embodiment)

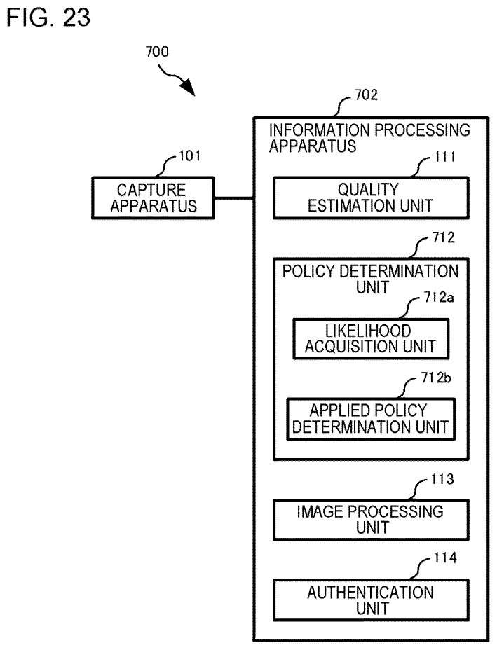

FIG. 23 is a diagram illustrating a configuration example of the information processing system 700 according to the seventh example embodiment. The information processing system 700 includes a capture apparatus 101 similar to that according to the first example embodiment, and an information processing apparatus 702 replacing an information processing apparatus 102 according to the first example embodiment.

The information processing apparatus 702 functionally includes, for example, a quality estimation unit 111, an image processing unit 113, and the recognition unit 114 similar to those according to the first example embodiment, and a policy determination unit 712 replacing a policy determination unit 112 according to the first example embodiment.

Similar to the policy determination unit 112 according to the first example embodiment, the policy determination unit 712 determines a network policy, based on quality information estimated by the quality estimation unit 111. The network policy is applied to a neural network that the image processing unit 113 uses for image processing (i.e., image processing of the target image).

The policy determination unit 712 according to the present example embodiment determines a network policy according to quality information of a target image by use of a trained first policy determination model. The first policy determination model is a machine learning model configured by use of a neural network.

The policy determination unit 712 functionally includes, for example, a likelihood acquisition unit 712a and an applied policy determination unit 712b.

The likelihood acquisition unit 712a derives a likelihood according to quality information of a target image regarding each of a plurality of previously determined network policies by use of a trained first policy determination model. That is to say, the first policy determination model according to the present example embodiment is a machine learning model that outputs a likelihood of each network policy once quality information of the target image is input.

Specifically, for example, the likelihood acquisition unit 712a inputs the quality information estimated by the quality estimation unit 111 to the trained first policy determination model, and derives a likelihood of each network policy.

The applied policy determination unit 712b determines a network policy to be applied to image processing of target image, based on the likelihood of each network policy derived by the likelihood acquisition unit 712a.

Specifically, for example, the applied policy determination unit 712b may determine a network policy being relevant to the maximum likelihood as a network policy to be applied to image processing of a target image. Moreover, for example, the applied policy determination unit 712b may determine the network policy to be applied to image processing of the target image, probabilistically in accordance with the likelihood.

Note that, a method of determining a network policy, based on a likelihood of each network policy is not limited to thereto.

The information processing system 700 according to the seventh example embodiment may be physically configured similar to an information processing system 100 according to the first example embodiment. However, a storage device 1040 of the information processing apparatus 702 stores a program module for achieving a function of the information processing apparatus 702. Moreover, a network interface 1050 of the information processing apparatus 702 is an interface for connecting the information processing apparatus 702 to a network.

### (Operation Example of the Information Processing System 700 According to the Seventh Example Embodiment)

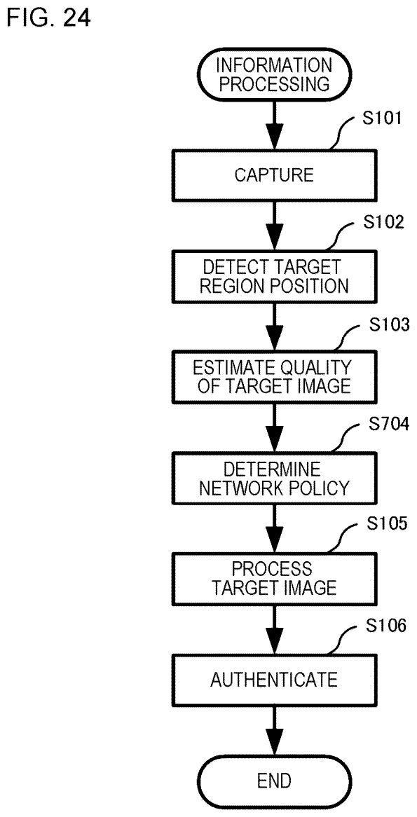

FIG. 24 is a flowchart illustrating one example of information processing according to the seventh example embodiment. As illustrated in the figure, the information processing according to the present example embodiment includes step S704 replacing step S104.

The policy determination unit 712 determines a network policy, based on quality of a target image estimated in step S103 (step S704).

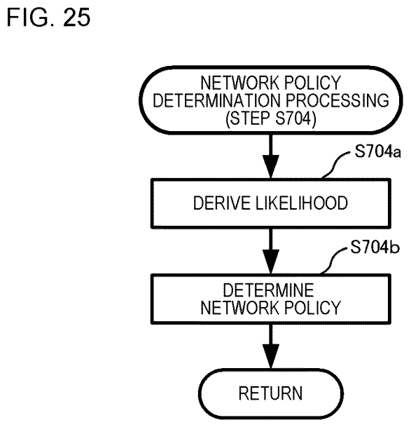

FIG. 25 is a flowchart illustrating an example of network policy determination processing (step S704) according to the seventh example embodiment.

The likelihood acquisition unit 712a derives a likelihood of each of a plurality of defined network policies, by use of a trained first policy determination model and quality information of the target image estimated in step S103 (step S704a).

The applied policy determination unit 712b determines, based on the likelihood of each of the network policies determined in step S704a, a network policy to be applied to image processing of the target image (step S704b), and returns to information processing.

### (Action and Effect)

As described above, according to the present example embodiment, the policy determination unit 712 determines a network policy according to quality information of a target image by use of a trained first policy determination model. The first policy determination model is configured by use of a neural network.

Thereby, a network policy according to quality of a target image can be determined. Then, processing in the neural network NN1 can be changed according to the determined network policy. Therefore, it becomes possible to perform recognition regardless of quality of the target image while suppressing an increase in a processing time.

### Eight Example Embodiment

In an eighth example embodiment, an example of a training method for a first policy determination model described in the seventh example embodiment is described. In the present example embodiment, in order to simplify description, description overlapping with the example embodiment described above is omitted as appropriate.

### (Configuration Example of an Information Processing System 800 According to the Eighth Example Embodiment)

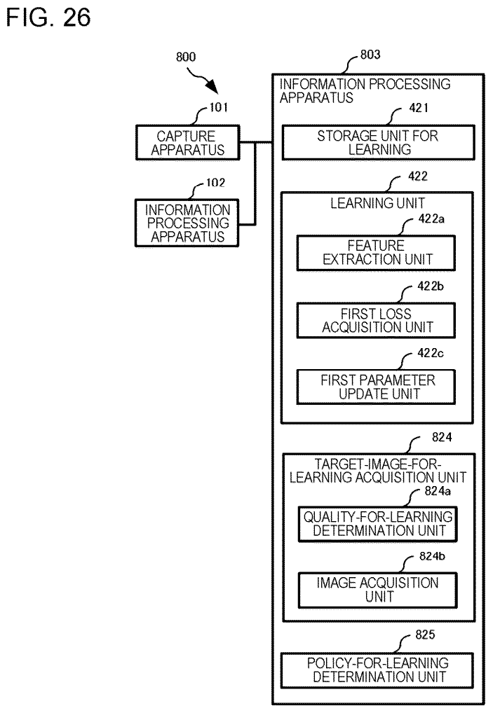

FIG. 26 is a diagram illustrating a configuration example of the information processing system 800 according to the eighth example embodiment. The information processing system 800 includes an information processing apparatus 803 in addition to a capture apparatus 101 and an information processing apparatus 102 similar to those according to the first example embodiment.

The information processing apparatus 803 is an apparatus for performing training of a first policy determination model and a neural network NN1. The information processing apparatus 803 includes a storage unit for training 421 and a training unit 422 similar to those according to the fourth example embodiment, a target-image-for-training acquisition unit 824, and a policy-for-training determination unit 825.

The target-image-for-training acquisition unit 824 determines quality of a target image for training, and acquires a target image for training, based on data for training stored in the storage unit for training 421.

Specifically, for example, the target-image-for-training acquisition unit 824 includes a quality-for-training determination unit 824a and an image acquisition unit 824b.

The quality-for-training determination unit 824a randomly determines quality of a target image for training in accordance with a previously determined probability distribution for training (e.g., refer to the fourth example embodiment).

The image acquisition unit 824b acquires a target image for training according to the quality determined by the quality-for-training determination unit 824a. For example, the image acquisition unit 824b may acquire an image of randomly determined quality from the storage unit for training 421. Moreover, for example, the image acquisition unit 824b may acquire an image from the storage unit for training 421, and acquire a target image for training by lowering the quality of the acquired image in accordance with the randomly determined quality.

The policy-for-training determination unit 825 performs training of the first policy determination model. For example, the policy-for-training determination unit 825 derives a likelihood of each of a plurality of network policies. The policy-for-training determination unit 825 determines a network policy to be applied to image processing of the target image for training, based on the likelihood of each of the network policies. In this case, it is preferable that the policy-for-training determination unit 825 determines a network policy by a method similar to that of the applied policy determination unit 712b. The policy-for-training determination unit 825 updates a parameter of the first policy determination model, based on a first loss.

It is preferable that the information processing apparatus 803 is physically configured similar to, for example, the information processing apparatus 102 (refer to FIG. 6). However, a storage device 1040 of the information processing apparatus 803 stores a program module for achieving a function of the information processing apparatus 803. Moreover, a network interface 1050 of the information processing apparatus 803 is an interface for connecting the information processing apparatus 803 to a network.

### (Operation Example of the Information Processing System 800 According to the Eighth Example Embodiment)

The information processing system 800 executes information processing. The information processing according to the present example embodiment includes, for example, training processing. The training processing is, for example, processing for performing training of the first policy determination model and the neural network NN1. For example, the information processing apparatus 803 starts the training processing once an instruction of a user is accepted.

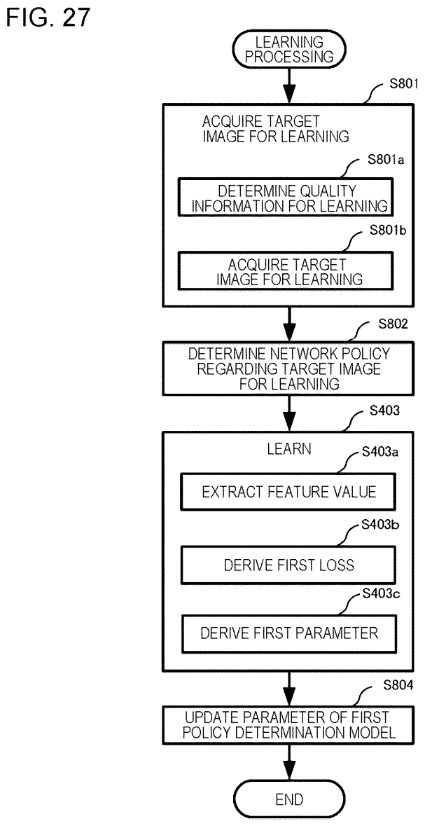

FIG. 27 is a flowchart illustrating one example of training processing according to the eighth example embodiment.

The target-image-for-training acquisition unit 824 acquires a target image for training of randomly determined quality (step S801).

Specifically, for example, the quality-for-training determination unit 824a randomly determines quality of the target image for training in accordance with a predetermined probability distribution for training (step S801a).

The image acquisition unit 824b acquires a target image for training of the quality determined in step S801a, for example, by use of the data for training stored in the storage unit for training 421 (step S801b).

The policy-for-training determination unit 825 determines, by use of the first policy determination model, a network policy regarding the target image for training acquired in step S801b (step S802).

Similar to the fourth example embodiment, the training unit 422 performs training of the neural network NN1 according to the network policy determined in step S802 (step S403).

The policy-for-training determination unit 825 updates a parameter (second parameter) of the first policy determination model by use of the first loss derived in step S403b (step S804), and ends the training processing.

Although the example in which training of the first policy determination model and the neural network NN1 is simultaneously performed has been described herein, training of the first policy determination model and the neural network NN1 may be performed separately. For example, in a case where training of only one of the first policy determination model and the neural network NN1 is performed, it is preferable to set a parameter of the other of the first policy determination model and the neural network NN1 to a fixed value.

### (Action and Effect)

As described above, according to the present example embodiment, the information processing apparatus 803 includes the policy-for-training determination unit 825 that performs training of the first policy determination model.

Thereby, a trained first policy determination model can be generated, and a network policy according to quality of the target image can be determined by use of the first policy determination model. Then, processing in the neural network NN1 can be changed according to the determined network policy. Therefore, it becomes possible to perform recognition regardless of quality of a target image while suppressing an increase in a processing time.

### Ninth Example Embodiment

In a ninth example embodiment, a detailed example of a training method of a first policy determination model described in the eighth example embodiment is described. In the present example embodiment, an example of performing training of the first policy determination model separately from training of a neural network NN1 is described. Moreover, in the present example embodiment, in order to simplify description, description overlapping with the example embodiment described above is omitted as appropriate.

### (Configuration Example of an Information Processing System According to the Ninth Example Embodiment)

In the information processing system according to the present example embodiment, an information processing apparatus according to the present example embodiment includes a policy-for-training determination unit 925 replacing a policy-for-training determination unit 825.

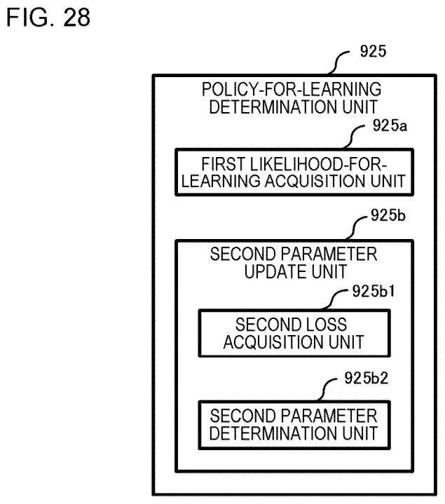

FIG. 28 is a diagram illustrating a configuration example of the policy-for-training determination unit 925 according to the ninth example embodiment. The policy-for-training determination unit 925 functionally includes, for example, a first likelihood-for-training acquisition unit 925a and a second parameter update unit 925b.

The first likelihood-for-training acquisition unit 925a inputs quality of a randomly determined target image for training to the first policy determination model, and derives a likelihood (vector) of each of a plurality of network policies.

The second parameter update unit 925b updates a parameter (second parameter) of the first policy determination model, based on a first loss and a likelihood regarding each of the plurality of network policies.

Specifically, for example, the second parameter update unit 925b includes a second loss acquisition unit 925b1 and a second parameter determination unit 925b2.

The second loss acquisition unit 925b1 derives a second loss (total loss) being a sum acquired by weighting the first loss with a likelihood regarding each of a plurality of network policies.

The second parameter determination unit 925b2 updates the (second parameter) of the first policy determination model, based on the second loss.

The information processing apparatus according to the present example embodiment may be physically configured similar to, for example, an information processing apparatus 802 (refer to FIG. 6). However, the storage device 1040 of the information processing apparatus according to the present example embodiment stores a program module for achieving a function of the information processing apparatus according to the present example embodiment. Moreover, a network interface 1050 of the information processing apparatus according to the present example embodiment is an interface for connecting the information processing apparatus according to the present example embodiment to a network.

### (Operation Example of an Information Processing System 900 According to the Ninth Example Embodiment)

The information processing system 900 executes information processing. The information processing according to the present example embodiment includes, for example, training processing. The training processing according to the present example embodiment includes first policy determination model training processing for performing training of the first policy determination model.

It is preferable to apply, for example, training processing according to the fourth and fifth example embodiments to training of the neural network NN1 and the like. Although an example in which training of the neural network NN1 is performed separately from training of the first policy determination model is described in the present example embodiment, training of the first policy determination model and the neural network NN1 may be performed simultaneously.

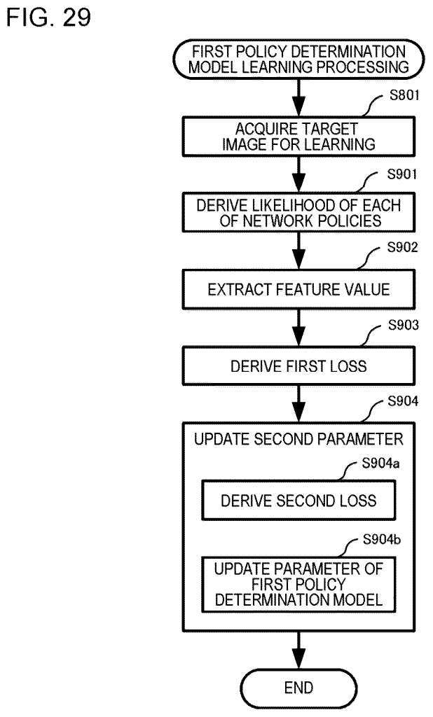

FIG. 29 is a flowchart illustrating an example of first policy determination model training processing according to the ninth example embodiment. For example, the information processing apparatus starts the first policy determination model training processing once an instruction of a user is accepted.

For example, first, the processing in step S801 similar to that according to the eighth example embodiment is executed.

The first likelihood-for-training acquisition unit 925a derives a likelihood (vector) regarding each of a plurality of network policies (step S901).

For example, the first likelihood-for-training acquisition unit 925a inputs quality of the target image for training randomly determined in step S801 (refer to step S801a in FIG. 27) to the first policy determination model, and derives a likelihood (vector) of each network policy.

The feature extraction unit 422a extracts a feature vector of the target image for training by use of a neural network NN1 according to each of a plurality of network policies (step S902).

The first loss acquisition unit 422b derives an error (first loss) between a feature vector extracted in step S902 and a correct answer value of the target image for training regarding each of a plurality of network policies (step S903).

The second parameter update unit 925b updates a parameter (second parameter) of the first policy determination model, based on the likelihood and the first loss derived in steps S901 and S902 (step S904).

Specifically, for example, the second loss acquisition unit 925b1 derives a second loss (total loss) being a sum acquired by weighting the first loss with a likelihood regarding each of a plurality of network policies (step S904a). Thereby, it is preferable that the second loss acquisition unit 925b1 derives a second loss function for computing the second loss.

The second parameter determination unit 925b2 updates (the second parameter) of the first policy determination model, based on the second loss derived in step S904a (step S904b), and ends the first policy determination model training processing.

For example, it is preferable that the second parameter determination unit 925b2 derives a gradient, based on the second loss function, and derives a second parameter used for update of the parameter included in the first policy determination model. Then, it is preferable that the second parameter determination unit 925b2 updates, by use of the derived second parameter, the parameter included in the first policy determination model. The first policy determination model training processing may be repeatedly executed until a predetermined condition is satisfied.

### (Action and Effect)

As described above, according to the present example embodiment, the information processing apparatus includes the policy-for-training determination unit 925 and the first loss acquisition unit 422b. The policy-for-training determination unit 925 performs training of a first policy determination model for determining a network policy according to quality information of a target image from among previously determined network policies. The first loss acquisition unit 422b derives a first loss in a case where the target image for training is processed by use of a neural network according to each of a plurality of network policies.

The first policy determination model is configured by a neural network.

The policy-for-training determination unit 925 includes the first likelihood-for-training acquisition unit 925a and the second parameter update unit 925b. The first likelihood-for-training acquisition unit 925a inputs quality information of the target image for training to the first policy determination model, and derives a likelihood of each network policy. The second parameter update unit 925b updates the parameter of the first policy determination model, based on the first loss and the likelihood of each network policy.

The second parameter update unit 925b includes the second loss acquisition unit 925b1 and the second parameter determination unit 925b2. The second loss acquisition unit 925b1 derives a second loss being a sum acquired by weighting the first loss with a likelihood regarding each of a plurality of network policies. The second parameter determination unit 925b2 updates a parameter of the first policy determination model, based on the second loss.

Thereby, a trained first policy determination model can be generated, and a network policy according to quality of the target image can be determined by use of the first policy determination model. Then, processing in the neural network NN1 can be changed according to the determined network policy. Therefore, it becomes possible to perform recognition regardless of quality of a target image while suppressing an increase in a processing time.

### Tenth Example Embodiment

In the seventh example embodiment, an example in which a network policy is determined by use of a first policy determination model configured by use of a neural network has been described. A neural network may not be used for the policy determination model for determining a network policy. In the present example embodiment, the policy determination model for determining a network policy may be made up of a plurality of probability distributions including a trainable parameter. It is preferable that the plurality of probability distributions are relevant to a plurality of previously determined network policies, respectively.

In the present example embodiment, the policy determination model made up of a plurality of probability distributions is referred to as a second policy determination model. Moreover, the probability distribution making up the second policy determination model is referred to as a policy probability distribution.

Moreover, in the present example embodiment, in order to simplify description, description overlapping with the example embodiment described above is omitted as appropriate.

### (Configuration Example of an Information Processing System 1100 According to the Tenth Example Embodiment)

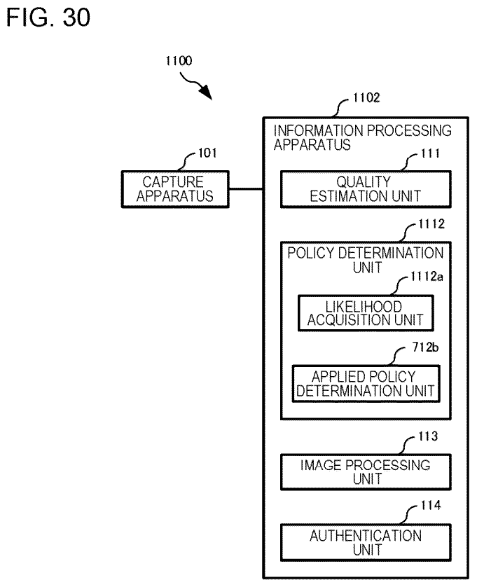

FIG. 30 is a diagram illustrating a configuration example of the information processing system 1100 according to the tenth example embodiment. The information processing system 1100 includes a capture apparatus 101 similar to that according to the first example embodiment, and an information processing apparatus 1102 replacing the information processing apparatus 102 according to the first example embodiment.

The information processing apparatus 1102 functionally includes, for example, a quality estimation unit 111, an image processing unit 113, and the recognition unit 114 similar to those according to the first example embodiment, and a policy determination unit 1112 replacing the policy determination unit 112 according to the first example embodiment.

Similar to the policy determination unit 112 according to the first example embodiment, the policy determination unit 1112 determines a network policy, based on the quality information estimated by the quality estimation unit 111. The network policy is applied to a neural network that the image processing unit 113 uses for image processing (i.e., image processing of the target image).

The policy determination unit 1112 according to the present example embodiment determines a network policy according to quality information of the target image by use of a trained second policy determination model. The second policy determination model is, for example, a model for determining a network policy according to the quality information of the target image from among previously determined network policies. The second policy determination model is made up of a plurality of policy probability distributions. Each of the plurality of policy probability distributions is relevant to each of a plurality of previously determined neural networks.

The policy determination unit 1112 functionally includes, for example, a likelihood acquisition unit 1112a, and an applied policy determination unit 712b similar to that according to the seventh example embodiment.

The likelihood acquisition unit 1112a derives a likelihood according to quality information of a target image regarding each of a plurality of previously determined network policies by use of the trained second policy determination model.

The second policy determination model according to the present example embodiment is made up of a plurality of policy probability distributions each being related to each of a plurality of network policies. The likelihood acquisition unit 1112a according to the present example embodiment derives a likelihood of each of the plurality of policy probability distributions.

It is preferable that the information processing system 1100 according to the tenth example embodiment is physically configured similar to, for example, the information processing system 100 according to the first example embodiment. However, a storage device 1040 of the information processing apparatus 1102 stores a program module for achieving a function of the information processing apparatus 1102. Moreover, the network interface 1050 of the information processing apparatus 1102 is an interface for connecting the information processing apparatus 1102 to a network.

### (Operation Example of the Information Processing System 1100 According to the Tenth Example Embodiment)

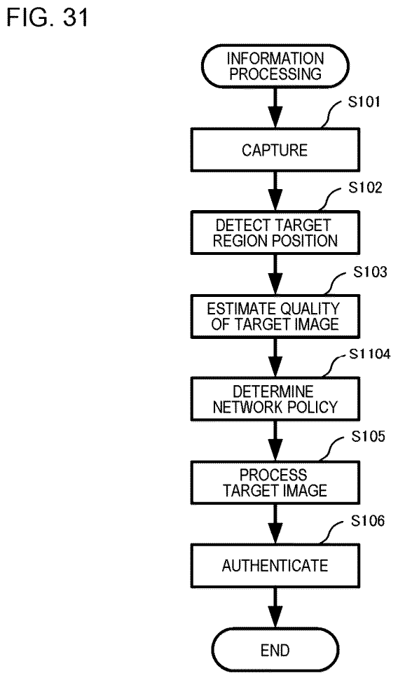

FIG. 31 is a flowchart illustrating one example of information processing according to the tenth example embodiment. As illustrated in the figure, the information processing according to the present example embodiment includes step S1104 replacing step S104.

The policy determination unit 1112 determines a network policy, based on quality of the target image estimated in step S103 (step S1104).

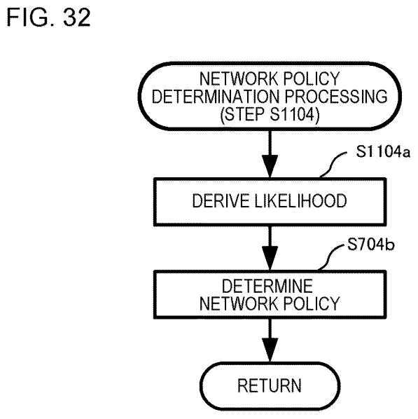

FIG. 32 is a flowchart illustrating an example of network policy determination processing (step S1104) according to the tenth example embodiment.

The likelihood acquisition unit 1112a derives a likelihood of each of a plurality of previously determined network policies by use of the trained second policy determination model and the quality information of the target image estimated in step S103 (step S1104a).

Specifically, for example, the likelihood acquisition unit 1112a derives a likelihood of each of a plurality of policy probability distributions making up the second policy determination model by use of the quality information of the target image estimated in step S103.

Similar to the seventh example embodiment, the applied policy determination unit 712b determines a network policy to be applied to image processing of the target image, based on the likelihood of each of the network policies derived in step S1104a (step S704b), and returns to information processing.

That is to say, for example, the applied policy determination unit 712b may determine a network policy being relevant to a policy probability distribution with the highest likelihood for the quality of the target image, as the network policy to be applied to the image processing of the target image.

Moreover, for example, the applied policy determination unit 712b may probabilistically determine a network policy to be applied to image processing of the target image, based on a likelihood of each policy probability distribution for quality of a target image. Specifically, for example, it is assumed that a likelihood in a case where quality of a target image is x is 0.2 for a policy probability distribution A, 0.5 for a policy probability distribution B, and 0.3 for a policy probability distribution C. In this case, it is preferable that the applied policy determination unit 712b selects, for example, network policies A, B, and C each being relevant to each of policy probability distributions A, B, and C, with probabilities of 20%, 50%, and 30% in order.

### (Action and Effect)

As described above, according to the present example embodiment, the policy determination unit 1112 determines a network policy according to quality information of a target image by use of a trained second policy determination model. The second policy determination model is made up of a plurality of policy probability distributions each being related to each of a plurality of network policies.

Thereby, a network policy according to quality of a target image can be determined. Then, processing in the neural network NN1 can be changed according to the determined network policy. Therefore, it becomes possible to perform recognition regardless of quality of a target image while suppressing an increase in a processing time.

### Eleventh Example Embodiment

In an eleventh example embodiment, an example of a training method of a second policy determination model described in the tenth example embodiment is described. Moreover, in the present example embodiment, in order to simplify description, description overlapping with the example embodiment described above is omitted as appropriate.

### (Configuration Example of an Information Processing System 1200 According to the Eleventh Example Embodiment)

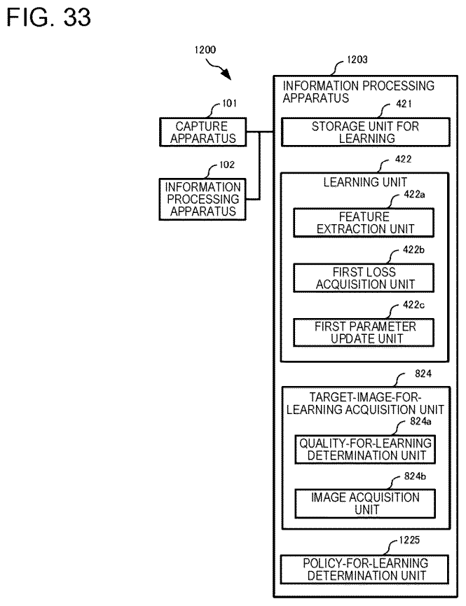

FIG. 33 is a diagram illustrating a configuration example of an information processing system 1200 according to the eleventh example embodiment. The information processing system 1200 includes an information processing apparatus 1203 in addition to a capture apparatus 101 and an information processing apparatus 102 similar to those according to the first example embodiment.

The information processing apparatus 1203 is an apparatus for performing training of a second policy determination model and a neural network NN1. The information processing apparatus 1203 includes a storage unit for training 421 and a training unit 422 similar to those according to the fourth example embodiment, a target-image-for-training acquisition unit 824 similar to that according to the eighth example embodiment, and a policy-for-training determination unit 1225.

The policy-for-training determination unit 1225 performs training of the second policy determination model. For example, the policy-for-training determination unit 1225 derives a likelihood of each of a plurality of network policies, i.e., a likelihood of each of a plurality of policy probability distributions making up the second policy determination model.

The policy-for-training determination unit 1225 determines a network policy to be applied to image processing of the target image for training, based on the likelihood of each of the policy probability distributions. In this case, for example, it is preferable that the policy-for-training determination unit 1125 determines a network policy by a method similar to that of the applied policy determination unit 712b. The policy-for-training determination unit 1225 updates a parameter (third parameter) of the second policy determination model, based on, for example, a first loss.

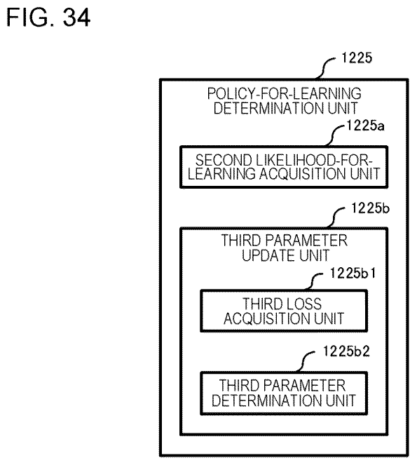

FIG. 34 is a diagram illustrating a functional configuration example of the policy-for-training determination unit 1225 according to the eleventh example embodiment. The policy-for-training determination unit 1225 includes, for example, a second likelihood-for-training acquisition unit 1225a and a third parameter update unit 1225b.

The second likelihood-for-training acquisition unit 1225a derives a likelihood (vector) regarding each of a plurality of network policies, based on quality of a randomly determined target image for training and a second policy determination model.

For example, the second likelihood-for-training acquisition unit 1225a derives a likelihood of each of the plurality of policy probability distributions making up the second policy determination model by use of the quality of the randomly determined target image for training.

The third parameter update unit 1225b updates a parameter of the second policy determination model, based on a first loss and a correction loss.

The correction loss is a loss for correcting in such a way that a difference of parameters of policy probability distributions being relevant to different network policies becomes larger. For example, in a case where averages of policy probability distributions A and B are μ_{A} and μ_{B}, respectively, a correction loss is a reciprocal (1/|μ_{A}−μ_{B}|) of a difference absolute value of μ_{A} and μ_{B}. Note that, the correction loss is not limited thereto.

The parameter of the second policy determination model is one or more parameters included in each of a plurality of policy probability distributions. As examples of a parameter, a variance, an average, and the like in a case where a policy probability distribution is a normal distribution can be cited. Note that, a parameter is not limited to thereto. Moreover, the policy probability distribution is not limited to a normal distribution.

Specifically, for example, the third parameter update unit 1225b includes a third loss acquisition unit 1225b1 and a third parameter determination unit 1225b2.

The third loss acquisition unit 1225b1 derives a third loss by adding the first loss and the correction loss. Note that, the third loss based on the first loss and the correction loss is not limited thereto.

The third parameter determination unit 1225b2 updates the parameter of each policy probability distribution, based on the third loss.

It is preferable that the information processing apparatus 1203 according to the present example embodiment is physically configured similar to, for example, an information processing apparatus 802 (refer to FIG. 6). However, a storage device 1040 of the information processing apparatus 1203 stores a program module for achieving a function of the information processing apparatus 1203. Moreover, a network interface 1050 of the information processing apparatus 1203 is an interface for connecting the information processing apparatus 1203 to a network.

### (Operation Example of the Information Processing System 1200 According to the Eleventh Example Embodiment)

The information processing system 1200 executes information processing. The information processing according to the present example embodiment includes training processing. The training processing is, for example, processing for performing training of a first policy determination model and the neural network NN1.

In the present example embodiment, an example in which training of the second policy determination model is performed separately from training of the neural network NN1 is described. It is preferable to apply, for example, the training processing according to the fourth and the fifth example embodiments to the training of the neural network NN1 and the like. Note that, the second policy determination model may be applied in place of the first policy determination model described in the eighth example embodiment, and training of the second policy determination model and the neural network NN1 may be performed simultaneously.

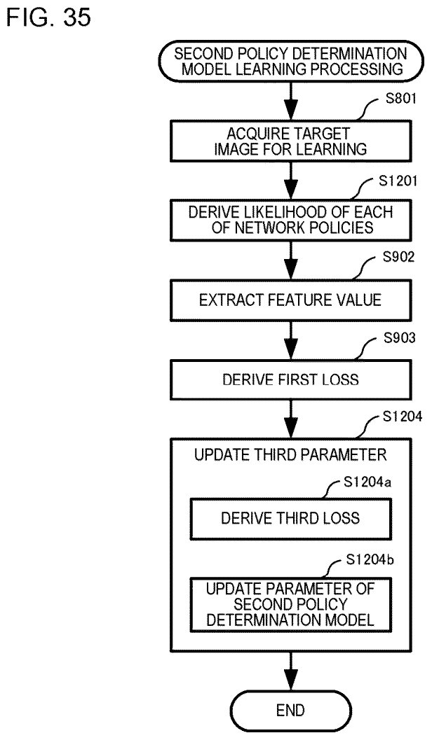

FIG. 35 is a flowchart illustrating an example of second policy determination model training processing according to the eleventh example embodiment. For example, the information processing apparatus starts the second policy determination model training processing once an instruction of a user is accepted.

For example, first, processing in step S801 similar to that according to the eighth example embodiment is executed.

The second likelihood-for-training acquisition unit 1225a derives a likelihood (vector) regarding each of a plurality of network policies (step S1201).

For example, the second likelihood-for-training acquisition unit 1225a derives a likelihood of each policy probability distribution according to quality of the target image for training randomly determined in step S801 (refer to step S801a in FIG. 27). The second likelihood-for-training acquisition unit 1225a may determine a network policy, based on the likelihood, by a method similar to that of the applied policy determination unit 712b.

The feature extraction unit 422a and the first loss acquisition unit 422b execute processing in steps S902 and S903 similar to those according to the ninth example embodiment, respectively. In a case where a network policy is determined in step S901, a feature vector and a first loss are derived by use of a neural network according to the network policy.

The third parameter update unit 1225b updates a parameter (third parameter) of the second policy determination model, based on the first loss derived in step S902 (step S1204).

Specifically, for example, the third loss acquisition unit 1225b1 derives the third loss by adding the first loss and the correction loss derived in step S902 (step S1204a). Thereby, it is preferable that the third loss acquisition unit 1225b1 derives a third loss function for computing the third loss.

The third parameter determination unit 1225b2 updates the parameter (third parameter) of each policy probability distribution, based on the third loss derived in step S1204a (step S1204b), and ends the second policy determination model training processing.

For example, it is preferable that the third parameter determination unit 1225b2 derives a gradient, based on the third loss function, and derives a third parameter used for update of the parameter included in the second policy determination model (each policy probability distribution). Then, it is preferable that the third parameter determination unit 1225b2 updates the parameter included in the second policy determination model (each policy probability distribution) by use of the derived third parameter. The second policy determination model training processing may be repeatedly executed until a predetermined condition is satisfied.

### (Action and Effect)

As described above, according to the present example embodiment, the information processing apparatus 1203 includes the policy-for-training determination unit 1225 and the first loss acquisition unit 422b. The policy-for-training determination unit 1225 performs training of a second policy determination model for determining a network policy according to quality information of a target image from among previously determined network policies. The first loss acquisition unit 422b derives a first loss in a case where the target image for training is processed by use of a neural network according to the network policy determined by use of the second policy determination model.

The second policy determination model is made up of a plurality of policy probability distributions each being relevant to each of a plurality of network policies. Each of the plurality of policy probability distributions includes one or more parameters.

The policy-for-training determination unit 1225 includes the second likelihood-for-training acquisition unit 1225a and the third parameter update unit 1225b. The second likelihood-for-training acquisition unit 1225a derives a likelihood of each policy probability distribution by use of quality information of the target image for training and each of a plurality of policy probability distributions. The third parameter update unit 1225b updates a parameter of each policy probability distribution, based on the first loss and a correction loss for correcting in such a way that a difference of parameters of policy probability distributions being relevant to different network policies becomes larger.

The third parameter update unit 1225b includes a third loss acquisition unit 1225b1 and a third parameter determination unit 1225b2. The third loss acquisition unit 1225b1 derives a third loss by adding the first loss and the correction loss. The third parameter determination unit 1225b2 updates the parameter of each policy probability distribution, based on the third loss.

Thereby, a trained second policy determination model can be generated, and a network policy according to quality of a target image can be determined by use of the second policy determination model. Then, processing in the neural network NN1 can be changed according to the determined network policy. Therefore, it becomes possible to perform recognition regardless of quality of a target image while suppressing an increase in a processing time.

Moreover, since image processing is generally easy in a high-quality image, there is a possibility of converging to a probability distribution for training in which a high-quality target image for training is sampled with high frequency, in a case where a parameter of each policy probability distribution is updated based on only the first loss. In the present example embodiment, a correction loss is taken into account in order to update the parameter of each policy probability distribution. Thereby, the probability distribution for training can be prevented from becoming such a probability distribution that a high-quality target image for training is sampled with high frequency. Therefore, it becomes possible to perform training of the second policy determination model by use of a target image for training acquired by selecting images of various qualities with an appropriate probability.

### Twelfth Example Embodiment

In a twelfth example embodiment, an example of a third policy determination model that determines a network policy with, as input, a target image itself in place of quality of the target image is described. The third policy determination model is configured by use of, for example, a neural network. In the present example embodiment, in order to simplify description, description overlapping with the example embodiment described above is omitted as appropriate.

### (Configuration Example of an Information Processing System 1300 According to the Twelfth Example Embodiment)

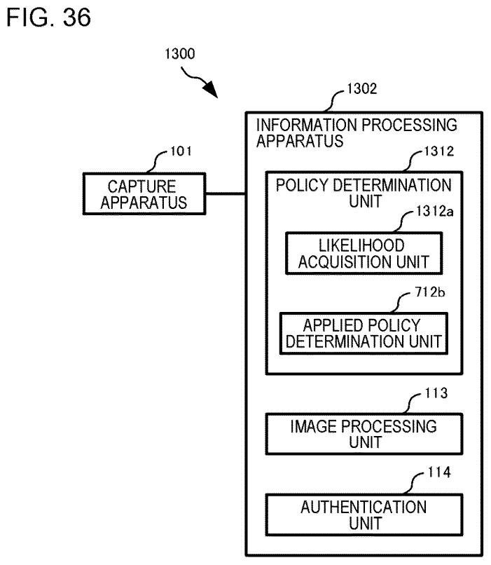

FIG. 36 is a diagram illustrating a configuration example of the information processing system 1300 according to the twelfth example embodiment. The information processing system 1300 includes a capture apparatus 101 similar to that according to the first example embodiment, and an information processing apparatus 1302 replacing an information processing apparatus 102 according to the first example embodiment.

The information processing apparatus 1302 functionally includes, for example, an image processing unit 113 and the recognition unit 114 similar to those according to the first example embodiment, and a policy determination unit 1312 replacing a policy determination unit 112 according to the first example embodiment.

The policy determination unit 1312 determines a network policy, based on the target image. The network policy is applied to a neural network that the image processing unit 113 uses for image processing (i.e., image processing of the target image).

The policy determination unit 1312 according to the present example embodiment determines a network policy according to the target image, by use of a trained third policy determination model. The third policy determination model is, for example, a machine learning model for determining a network policy according to the target image from among a plurality of previously determined network policies. The third policy determination model is configured by use of a neural network.

The policy determination unit 1312 functionally includes, for example, a likelihood acquisition unit 1312a, and an applied policy determination unit 712b similar to that according to the seventh example embodiment.

The likelihood acquisition unit 1312a derives a likelihood according to the target image regarding each of a plurality of previously determined network policies by use of the trained third policy determination model. That is to say, the third policy determination model according to the present example embodiment is a machine learning model that outputs a likelihood of each network policy once a target image is input.

In detail, for example, the likelihood acquisition unit 1312a inputs the target image to the trained third policy determination model, and derives a likelihood of each network policy.

It is preferable that the information processing system 1300 according to the twelfth example embodiment is physically configured similar to, for example, the information processing system 100 according to the first example embodiment. However, a storage device 1040 of the information processing apparatus 1302 stores a program module for achieving a function of the information processing apparatus 1302. Moreover, a network interface 1050 of the information processing apparatus 1302 is an interface for connecting the information processing apparatus 1302 to a network.

### (Operation Example of the Information Processing System 1300 According to the Twelfth Example Embodiment)

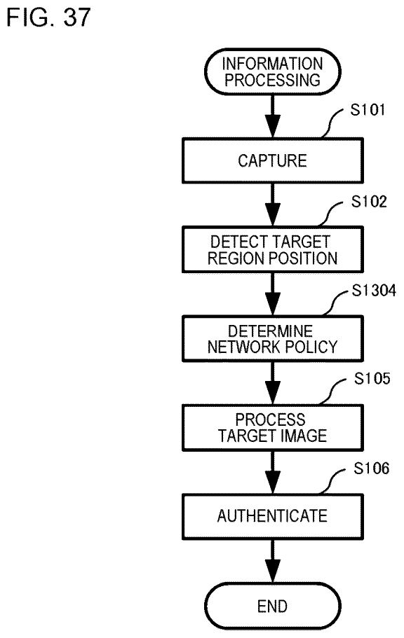

FIG. 37 is a flowchart illustrating one example of information processing according to the twelfth example embodiment. As illustrated in the figure, the information processing according to the present example embodiment includes step S1304 replacing step S104. Moreover, the information processing according to the present example embodiment may not include step S103.

The policy determination unit 1312 determines a network policy, based on the target image (step S1304).

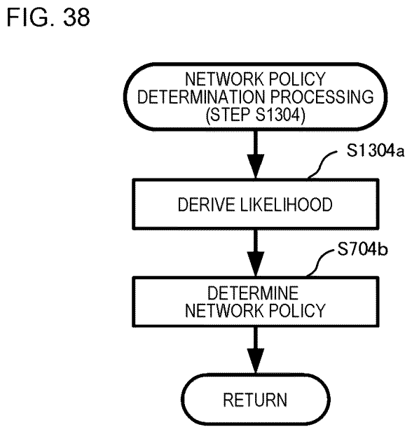

FIG. 38 is a flowchart illustrating an example of network policy determination processing (step S1304) according to the twelfth example embodiment.

The likelihood acquisition unit 1312a derives a likelihood of each of a plurality of previously determined network policies by use of the target image and the trained third policy determination model (step S1304a).

Similar to the seventh example embodiment, the applied policy determination unit 712b determines a network policy to be applied to image processing of the target image, based on the likelihood of each of the network policies derived in step S1304a (step S704b), and returns to information processing.

### (Action and Effect)

As described above, according to the present example embodiment, the policy determination unit 1312 determines a network policy according to a target image by use of the trained third policy determination model. The third policy determination model is configured by use of a neural network.

Thereby, a network policy according to a target image can be determined. Then, processing in the neural network NN1 can be changed according to the determined network policy. Therefore, it becomes possible to perform recognition regardless of quality of the target image while suppressing an increase in a processing time.

### Thirteenth Example Embodiment

In a thirteenth example embodiment, an example of a training method of a third policy determination model described in the twelfth example embodiment is described. In training of the third policy determination model, a trained policy determination model (a first policy determination model, a second policy determination model, or the like) is used. In the present example embodiment, an example in which the first policy determination model is used for training of the third policy determination model is described.

Moreover, in the present example embodiment, in order to simplify description, description overlapping with the example embodiment described above is omitted as appropriate.

### (Configuration Example of an Information Processing System 1400 According to a Thirteenth Example Embodiment)

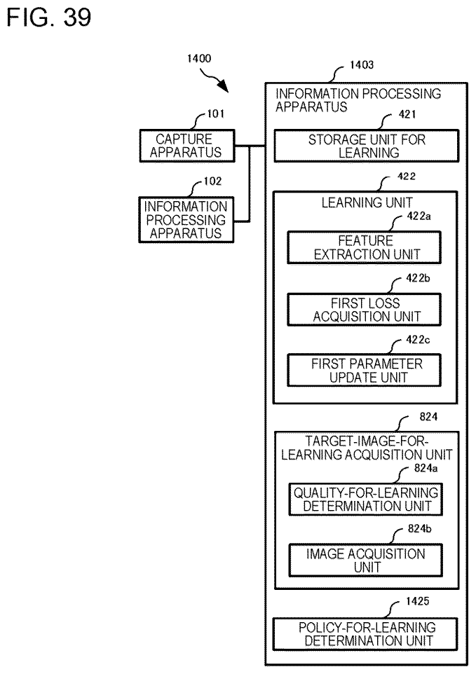

FIG. 39 is a diagram illustrating a configuration example of the information processing system 1400 according to the thirteenth example embodiment. The information processing system 1400 includes an information processing apparatus 1403 in addition to a capture apparatus 101 and an information processing apparatus 102 similar to those according to the first example embodiment.

The information processing apparatus 1403 is an apparatus for performing training of a third policy determination model and a neural network NN1. The information processing apparatus 1403 includes a storage unit for training 421 and a training unit 422 similar to those according to the fourth example embodiment, a target-image-for-training acquisition unit 824 similar to that according to the eighth example embodiment, and a policy-for-training determination unit 1425.

The policy-for-training determination unit 1425 performs training of the third policy determination model by use of a trained first policy determination model. For example, the policy-for-training determination unit 1425 acquires, regarding each of a plurality of network policies, a likelihood based on the first policy determination model (a likelihood of a correct answer) and a likelihood based on the third policy determination model (a likelihood during training). Then, the policy-for-training determination unit 1425 performs training of the third policy determination model in such a way that the likelihood during training approaches the correct answer likelihood.

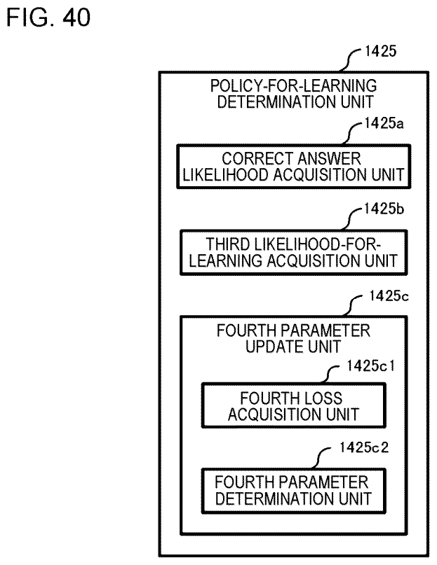

FIG. 40 is a diagram illustrating a functional configuration example of the policy-for-training determination unit 1425 according to the thirteenth example embodiment. The policy-for-training determination unit 1425 includes, for example, a correct answer likelihood acquisition unit 1425a, a third likelihood-for-training acquisition unit 1425b, and a fourth parameter update unit 1425c.

The correct answer likelihood acquisition unit 1425a inputs quality of a randomly determined target image for training to the trained first policy determination model, and derives a likelihood (vector) of each of a plurality of network policies as a correct answer likelihood.

The third likelihood-for-training acquisition unit 1425b inputs a target image for training according to the randomly determined quality to the third policy determination model, and derives a likelihood (vector) of each network policy as a likelihood during training.

The fourth parameter update unit 1425c updates a parameter (fourth parameter) of the third policy determination model, based on a fourth loss, in such a way that the likelihood during training approaches the correct answer likelihood. The fourth loss is, for example, an error between a correct answer likelihood derived regarding a plurality of network policies and the likelihood during training. For example, it is preferable that cross entropy (error), a mean squared error, a mean absolute error (MAE), or the like is used as the fourth loss.

Specially, for example, the fourth parameter update unit 1425c includes a fourth loss acquisition unit 1425c1 and a fourth parameter determination unit 1425c2.

The fourth loss acquisition unit 1425c1 derives the fourth loss, based on the correct answer likelihood derived regarding a plurality of network policies and the likelihood during training.

The fourth parameter determination unit 1425c2 updates a parameter of the third policy determination model, based on the fourth loss.

It is preferable that the information processing apparatus 1403 according to the present example embodiment is physically configured similar to, for example, the information processing apparatus 802 (refer to FIG. 6). However, a storage device 1040 of the information processing apparatus 1403 stores a program module for achieving a function of the information processing apparatus 1403. Moreover, a network interface 1050 of the information processing apparatus 1403 is an interface for connecting the information processing apparatus 1403 to a network.

### (Operation Example of the Information Processing System 1400 According to the Thirteenth Example Embodiment)

The information processing system 1400 executes information processing. The information processing according to the present example embodiment includes training processing. The training processing is, for example, processing for performing training of the third policy determination model and the neural network NN1.

In the present example embodiment, an example in which training of the third policy determination model is performed separately from the training of the neural network NN1 is described. It is preferable to apply, for example, the training processing according to the fourth and the fifth example embodiments to the training of the neural network NN1 and the like. Note that, the third policy determination model may be applied in place of the first policy determination model described in the eighth example embodiment, and training of the third policy determination model and the neural network NN1 may be performed simultaneously.

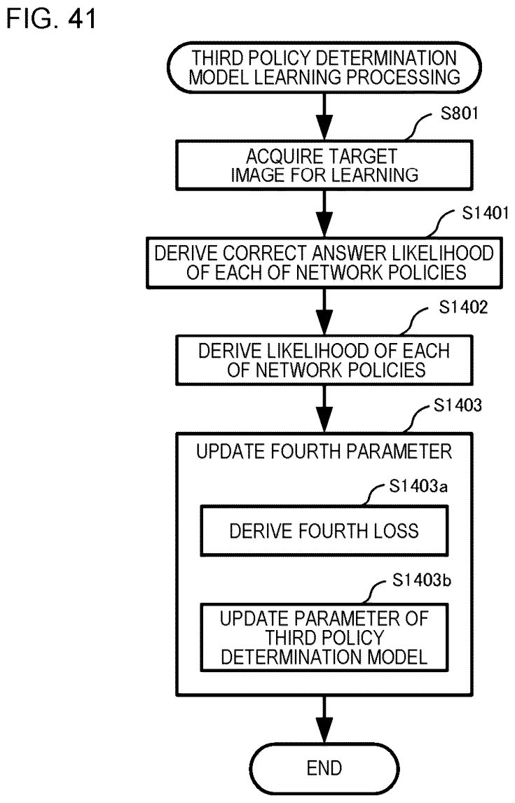

FIG. 41 is a flowchart illustrating an example of a third policy determination model training processing according to the thirteenth example embodiment. For example, the information processing apparatus starts the third policy determination model training processing once an instruction of a user is accepted.

For example, first, processing in step S801 similar to that according to the eighth example embodiment is executed.

The correct answer likelihood acquisition unit 1425a inputs quality of the target image for training randomly determined in step S801a to the trained first policy determination model, and derives a correct answer likelihood for each of a plurality of network policies (step S1401).

For example, the correct answer likelihood acquisition unit 1425a previously holds a trained first policy determination model. The correct answer likelihood acquisition unit 1425a inputs quality of a randomly determined target image for training into the previously held first policy determination model, and thereby derives a correct answer likelihood (vector) of each of a plurality of network policies.

The third likelihood-for-training acquisition unit 1425b inputs the target image for training acquired in step S801b to the third policy determination model, and derives a likelihood during training of each network policy (step S1402).

For example, the third likelihood-for-training acquisition unit 1425b inputs the target image for training acquired in step S801b to the third policy determination model. Thereby, the third likelihood-for-training acquisition unit 1425b derives a likelihood during training regarding each of a plurality of network policies.

The fourth parameter update unit 1425c updates a parameter (fourth parameter) of the third policy determination model in such a way that the correct answer likelihood and the likelihood during training derived in steps S1401 and S1402 approach (step S1403).

Specifically, for example, the fourth loss acquisition unit 1425c1 derives a fourth loss, based on a correct answer likelihood and a likelihood during training derived regarding a plurality of network policies (step S1403a). Thereby, the fourth loss acquisition unit 1425c1 derives a fourth loss function for computing the fourth loss.

The fourth parameter determination unit 1425c2 updates a parameter of the third policy determination model, based on the fourth loss derived in step S1403a (step S1403b), and ends the third policy determination model training processing.

For example, it is preferable that the fourth parameter determination unit 1425c2 derives a gradient, based on the fourth loss function, and derives a fourth parameter to be used for update of the third policy determination model. Then, the fourth parameter determination unit 1425c2 updates, by use of the derived fourth parameter, the parameter included in the third policy determination model. The third policy determination model training processing may be repeatedly executed until a predetermined condition is satisfied.

### (Action and Effect)

As described above, according to the present example embodiment, the information processing apparatus 1403 further includes the policy-for-training determination unit 1425. The policy-for-training determination unit 1425 performs training of a third policy determination model for determining a network policy according to a target image from among a plurality of previously determined network policies.

The policy-for-training determination unit 1425 includes the correct answer likelihood acquisition unit 1425a, the third likelihood-for-training acquisition unit 1425b, and the fourth parameter update unit 1425c.

The correct answer likelihood acquisition unit 1425a inputs quality information of a target image for training to a trained first policy determination model for determining a network policy according to the quality information of the target image from among a plurality of previously determined network policies, and derives a likelihood of each network policy as a correct answer likelihood. The third likelihood-for-training acquisition unit 1425b inputs the target image for training to the third policy determination model, and derives a likelihood of each network policy as a likelihood during training. The fourth parameter update unit 1425c updates, based on a fourth loss, a parameter of the third policy determination model in such a way that the likelihood during training approaches the correct answer likelihood.

The fourth loss is a loss based on an error between the likelihood during training and the correct answer likelihood.

Thereby, a trained third policy determination model can be generated, and a network policy according to a target image can be determined by use of the third policy determination model. Then, processing in the neural network NN1 can be changed according to the determined network policy. Therefore, it becomes possible to perform recognition regardless of quality of the target image while suppressing an increase in a processing time.

The example embodiments and the modified examples of the present invention have been described above with reference to the drawings, but are exemplifications of the present invention, and various configurations other than those described above can be adopted.

Moreover, although a plurality of processes (pieces of processing) are described in order in a plurality of flowcharts used in the above description, an execution order of processes executed in each example embodiment is not limited to the described order. In each example embodiment, an order of illustrated processes can be changed to an extent that causes no problem in terms of content. Moreover, the example embodiments and the modified examples described above can be combined to an extent that content does not contradict.

Some or all of the above-described example embodiments can also be described as, but are not limited to, the following supplementary notes.
1. An information processing system including:
   a quality estimation unit that estimates quality information of a target image; and
   an image processing unit that processes the target image by use of a neural network according to a network policy determined based on the quality information of the target image.
2. The information processing system according to supplementary note 1, wherein
   the image processing unit extracts a feature vector from the target image by use of the neural network according to the network policy.
3. The information processing system according to supplementary note 1 or 2, wherein
   the target image is an eye image including an iris region in which an iris is shown, and
   the quality information includes an iris diameter.
4. The information processing system according to any one of supplementary notes 1 to 3, wherein
   the quality information includes resolution of the target image.
5. The information processing system according to any one of supplementary notes 1 to 4, further including
   a policy determination unit that determines the network policy, based on the quality information.
6. The information processing system according to supplementary note 5, wherein
   the policy determination unit determines the network policy in such a way that a time of processing using the neural network falls within a previously determined range, regardless of quality information of the target image.
7. The information processing system according to any one of supplementary notes 1 to 6, wherein
   the image processing unit includes
   a first processing unit that converts the iris region included in the target image into a standard image with a previously determined shape, and
   a second processing unit that processes the standard image by use of the neural network according to the network policy, and
   the first processing unit converts the iris region into the standard image with a size according to the quality information.
8. The information processing system according to any one of supplementary notes 1 to 7, wherein
   the neural network is made up of a front-stage group including an input layer, and a rear-stage group including a final layer, and
   the network policy is applied to image processing using the front-stage group.
9. The information processing system according to supplementary note 8, wherein
   the neural network includes a plurality of convolution layers, and
   the policy determination unit determines the network policy in such a way that a number of the convolution layers included in the front-stage group is larger as resolution of the target image is lower.
10. The information processing system according to supplementary note 8, wherein
   the neural network includes a plurality of convolution layers, and
   the policy determination unit determines the network policy in such a way that a number of channels in an arithmetic operation in the convolution layer included in the front-stage group is larger as resolution of the target image is lower.
11. The information processing system according to any one of supplementary notes 1 to 10, further including
   a training unit that performs training of the neural network by inputting a target image for training to the neural network.
12. The information processing system according to supplementary note 11, further including
   a policy-for-training determination unit that determines a network policy regarding the target image for training, based on quality information of the target image for training and a probability distribution for training, wherein
   the training unit performs training of the neural network by inputting the target image for training to the neural network according to the determined network policy, and
   the probability distribution for training is a probability distribution being highest in probability with quality indicated by quality information of the target image for training, and becoming gradually lower in probability as a degree of being different from the quality becomes larger.
13. The information processing system according to supplementary note 12, wherein
   the policy-for-training determination unit further includes
   a first determination unit that changes quality information of the target image for training according to a probability distribution for training by using the random number, and determines quality information for training, and
   a second determination unit that determines a network policy regarding the target image for training according to the determined quality information for training.
14. The information processing system according to any one of supplementary notes 11 to 13, further including
   an image selection unit that selects a target image for training in such a way that more target images for training with lower quality are selected, wherein
   the training unit performs training of the neural network by inputting the selected target image for training to the neural network.
15. The information processing system according to supplementary note 11, further including:
   a policy-for-training determination unit that performs training of a first policy determination model for determining the network policy according to quality information of the target image from among a plurality of previously determined network policies; and
   a first loss acquisition unit that derives a first loss in a case where the target image for training is processed by use of a neural network according to each of the plurality of network policies, wherein
   the first policy determination model is configured from a neural network,
   the policy-for-training determination unit includes
   a first likelihood-for-training acquisition unit that inputs quality information of the target image for training to the first policy determination model, and derives a likelihood of each network policy,
and
   a second parameter update unit that updates a parameter of the first policy determination model, based on the first loss and the likelihood of each of the network policies, and
   the second parameter update unit includes
   a second loss acquisition unit that derives a second loss being a sum acquired by weighting a first loss with a likelihood regarding each of the network policies, and
   a second parameter update unit that updates a parameter of the first policy determination model, based on the second loss.
16. The information processing system according to supplementary note 11, further including:
   a policy-for-training determination unit that performs training of a second policy determination model for determining the network policy according to quality information of the target image from among a plurality of previously determined network policies; and
   a first loss acquisition unit that derives a first loss in a case where the target image for training is processed by use of a neural network according to the network policy determined by use of the second policy determination model, wherein
   the second policy determination model is made up of a plurality of policy probability distributions each being related to each of the plurality of network policies,
   each of the plurality of policy probability distributions includes one or more parameters,
   the policy-for-training determination unit includes
   a second likelihood-for-training acquisition unit that derives a likelihood of each policy probability distribution by use of quality information of the target image for training and each of the plurality of policy probability distributions, and
   a third parameter update unit that updates the parameter of each of the policy probability distributions, based on the first loss, and a correction loss for correcting in such a way that a difference of parameters of policy probability distributions being relevant to different network policies becomes larger, and
   the third parameter update unit includes
   a third loss acquisition unit that derives a third loss by adding the first loss and a correction loss, and
   a third parameter determination unit that updates the parameter of each of the policy probability distributions, based on the third loss.
17. The information processing system according to supplementary note 11, further including
   a policy-for-training determination unit that performs training of a third policy determination model for determining the network policy according to the target image from among a plurality of previously determined network policies, wherein
   the policy-for-training determination unit includes
   a correct answer likelihood acquisition unit that inputs quality information of the target image for training to a trained first policy determination model for determining the network policy according to quality information of the target image from among a plurality of previously determined network policies, and derives a likelihood of each of the network policies as a correct answer likelihood,
   a third likelihood-for-training acquisition unit that inputs the target image for training to a third policy determination model, and derives a likelihood of each network policy as a likelihood during training, and
   a fourth parameter update unit that updates a parameter of a third policy determination model, based on a fourth loss, in such a way that the likelihood during training approaches the correct answer likelihood, and
   the fourth loss is a loss based on an error between the likelihood during training and the correct answer likelihood.
18. An information processing apparatus including:
   a quality estimation unit that estimates quality information of a target image; and
   an image processing unit that processes the target image by use of a neural network according to a network policy determined based on the quality information of the target image.
19. An information processing method including:
   by one or more computers,
   estimating quality information of a target image; and
   processing the target image by use of a neural network according to a network policy determined based on the quality information of the target image.
20. The information processing method according to supplementary note 19, further including,
   in processing the target image, extracting a feature vector from the target image by use of the neural network according to the network policy.
21. The information processing method according to supplementary note 19 or 20, wherein
   the target image is an eye image including an iris region in which an iris is shown, and
   the quality information includes an iris diameter.
22. The information processing method according to any one of supplementary notes 19 to 21, wherein
   the quality information includes resolution of the target image.
23. The information processing method according to any one of supplementary notes 19 to 22, further including
   determining the network policy, based on the quality information.
24. The information processing method according to supplementary note 23, further including,
   in determining the network policy, determining the network policy in such a way that a time of processing using the neural network falls within a previously determined range, regardless of quality information of the target image.
25. The information processing method according to any one of supplementary notes 19 to 24, further including
   in processing the target image,
   converting the iris region included in the target image into a standard image with a previously determined shape, and
   processing the standard image by use of the neural network according to the network policy, and
   in converting into the standard image, converting the iris region into the standard image with a size according to the quality information.
26. The information processing method according to any one of supplementary notes 19 to 25, wherein
   the neural network is made up of a front-stage group including an input layer, and a rear-stage group including a final layer, and
   the network policy is applied to image processing using the front-stage group.
27. The information processing method according to supplementary note 26, wherein
   the neural network includes a plurality of convolution layers,
   the information processing method further including, in determining the network policy, determining the network policy in such a way that a number of the convolution layers included in the front-stage group is larger as resolution of the target image is lower.
28. The information processing method according to supplementary note 26, wherein
   the neural network includes a plurality of convolution layers,
   the information processing method further including, in determining the network policy, determining the network policy in such a way that a number of channels in an arithmetic operation in the convolution layer included in the front-stage group is larger as resolution of the target image is lower.
29. The information processing method according to any one of supplementary notes 19 to 28, further including
   performing training of the neural network by inputting a target image for training to the neural network.
30. The information processing method according to supplementary note 29, further including,
   determining a network policy regarding the target image for training, based on quality information of the target image for training and a probability distribution for training, and
   in performing training of the neural network, performing training of the neural network by inputting the target image for training to the neural network according to the determined network policy, wherein
   the probability distribution for training is a probability distribution being highest in probability with quality indicated by quality information of the target image for training, and becoming gradually lower in probability as a degree of being different from the quality becomes larger.
31. The information processing method according to supplementary note 30, further including,
   in determining a network policy regarding the target image for training,
   changing quality information of the target image for training according to a probability distribution for training by using the random number, and determining quality information for training, and
   determining a network policy regarding the target image for training according to the determined quality information for training.
32. The information processing method according to any one of supplementary notes 29 to 31, further including
   selecting a target image for training in such a way that more target images for training with lower quality are selected, and
   in performing training of the neural network, performing training of the neural network by inputting the selected target image for training to the neural network.
33. The information processing method according to supplementary note 29, further including:
   performing training of a first policy determination model for determining the network policy according to quality information of the target image from among a plurality of previously determined network policies; and
   deriving a first loss in a case where the target image for training is processed by use of a neural network according to each of the plurality of network policies, wherein
   the first policy determination model is configured from a neural network,
   the information processing method further including, in performing training of the first policy determination model,
   inputting quality information of the target image for training to the first policy determination model, and deriving a likelihood of each network policy, and
   updating a parameter of the first policy determination model, based on the first loss and the likelihood of each of the network policies, and
   in updating a parameter of the first policy determination model,
   deriving a second loss being a sum acquired by weighting a first loss with a likelihood regarding each of the network policies, and
   updating a parameter of the first policy determination model, based on the second loss.
34. The information processing method according to supplementary note 29, further including:
   performing training of a second policy determination model for determining the network policy according to quality information of the target image from among a plurality of previously determined network policies; and
   deriving a first loss in a case where the target image for training is processed by use of a neural network according to the network policy determined by use of the second policy determination model, wherein
   the second policy determination model is made up of a plurality of policy probability distributions each being related to each of the plurality of network policies, and
   each of the plurality of policy probability distributions includes one or more parameters,
   the information processing method further including, in performing training of the second policy determination model:
   deriving a likelihood of each policy probability distribution by use of quality information of the target image for training and each of the plurality of policy probability distributions; and
   updating the parameter of each of the policy probability distributions, based on the first loss, and a correction loss for correcting in such a way that a difference of parameters of policy probability distributions being relevant to different network policies becomes larger, and
   in updating the parameter of each of the policy probability distributions,
   deriving a third loss by adding the first loss and a correction loss; and
   updating the parameter of each of the policy probability distributions, based on the third loss.
35. The information processing method according to supplementary note 29, further including
   performing training of a third policy determination model for determining the network policy according to the target image from among a plurality of previously determined network policies;
   in performing training of the third policy determination model,
   inputting quality information of the target image for training to a trained first policy determination model for determining the network policy according to quality information of the target image from among a plurality of previously determined network policies, and deriving a likelihood of each of the network policies as a correct answer likelihood;
   inputting the target image for training to a third policy determination model, and deriving a likelihood of each network policy as a likelihood during training; and
   updating a parameter of a third policy determination model, based on a fourth loss, in such a way that the likelihood during training approaches the correct answer likelihood, wherein
   the fourth loss is a loss based on an error between the likelihood during training and the correct answer likelihood.
36. A medium recording a program for causing one or more computers to execute:
   estimating quality information of a target image; and
   processing the target image by use of a neural network according to a network policy determined based on the quality information of the target image.
37. The medium according to supplementary note 36, recording a program for,
   in processing the target image, extracting a feature vector from the target image by use of the neural network according to the network policy.
38. The medium according to supplementary note 36 or 37, recording a program for
   the target image to be an eye image including an iris region in which an iris is shown, and
   the quality information to include an iris diameter.
39. The medium according to any one of supplementary notes 36 to 38, recording a program, wherein
   the quality information includes resolution of the target image.
40. The medium according to any one of supplementary notes 36 to 39, recording a program for causing to further execute
   determining the network policy, based on the quality information.
41. The medium according to supplementary note 40, recording a program for,
   in determining the network policy, determining the network policy in such a way that a time of processing using the neural network falls within a previously determined range, regardless of quality information of the target image.
42. The medium according to any one of supplementary notes 36 to 41, recording a program for
   in processing the target image,
   converting the iris region included in the target image into a standard image with a previously determined shape, and
   processing the standard image by use of the neural network according to the network policy, and
   in converting into the standard image, converting the iris region into the standard image with a size according to the quality information.
43. The medium according to any one of supplementary notes 36 to 42, recording a program for
   the neural network to be made up of a front-stage group including an input layer, and a rear-stage group including a final layer, and
   the network policy to be applied to image processing using the front-stage group.
44. The medium according to supplementary note 43, wherein
   the neural network includes a plurality of convolution layers, and
   the medium recording a program for, in determining the network policy, determining the network policy in such a way that a number of the convolution layers included in the front-stage group is larger as resolution of the target image is lower.
45. The medium according to supplementary note 43, wherein
   the neural network includes a plurality of convolution layers,
   the medium recording a program for, in determining the network policy, determining the network policy in such a way that a number of channels in an arithmetic operation in the convolution layer included in the front-stage group is larger as resolution of the target image is lower.
46. The medium according to any one of supplementary notes 36 to 45, recording a program for further including
   performing training of the neural network by inputting a target image for training to the neural network.
47. The medium according to supplementary note 46, recording a program for further including
   determining a network policy regarding the target image for training, based on quality information of the target image for training and a probability distribution for training,
   the medium recording a program for, in performing training of the neural network, performing training of the neural network by inputting the target image for training to the neural network according to the determined network policy, wherein
   the probability distribution for training is a probability distribution being highest in probability with quality indicated by quality information of the target image for training, and becoming gradually lower in probability as a degree of being different from the quality becomes larger.
48. The medium according to supplementary note 47, recording a program for,
   in determining a network policy regarding the target image for training,
   changing quality information of the target image for training according to a probability distribution for training by using the random number, and determining quality information for training, and
   determining a network policy regarding the target image for training according to the determined quality information for training.
49. The medium according to any one of supplementary notes 46 to 48, further including
   selecting a target image for training in such a way that more target images for training with lower quality are selected,
   the medium recording a program for, in performing training of the neural network, performing training of the neural network by inputting the selected target image for training to the neural network.
50. The medium according to supplementary note 46, further including:
   performing training of a first policy determination model for determining the network policy according to quality information of the target image from among a plurality of previously determined network policies; and
   deriving a first loss in a case where the target image for training is processed by use of a neural network according to each of the plurality of network policies, wherein
   the first policy determination model is configured from a neural network,
   the medium recording a program for,
   in performing training of the first policy determination model,
   inputting quality information of the target image for training to the first policy determination model, and deriving a likelihood of each network policy,
and
   updating a parameter of the first policy determination model, based on the first loss and the likelihood of each of the network policies, and
   in updating a parameter of the first policy determination model,
   deriving a second loss being a sum acquired by weighting a first loss with a likelihood regarding each of the network policies, and
   updating a parameter of the first policy determination model, based on the second loss.
51. The medium according to supplementary note 46, further including:
   performing training of a second policy determination model for determining the network policy according to quality information of the target image from among a plurality of previously determined network policies; and
   deriving a first loss in a case where the target image for training is processed by use of a neural network according to the network policy determined by use of the second policy determination model, wherein
   the second policy determination model is made up of a plurality of policy probability distributions each being related to each of the plurality of network policies, and
   each of the plurality of policy probability distributions includes one or more parameters,
   the medium recording a program for,
   in performing training of the second policy determination model,
   deriving a likelihood of each policy probability distribution by use of quality information of the target image for training and each of the plurality of policy probability distributions, and
   updating the parameter of each of the policy probability distributions, based on the first loss, and a correction loss for correcting in such a way that a difference of parameters of policy probability distributions being relevant to different network policies becomes larger, and
   in updating the parameter of each of the policy probability distributions,
   deriving a third loss by adding the first loss and a correction loss, and
   updating the parameter of each of the policy probability distributions, based on the third loss.
52. The medium according to supplementary note 46, further including performing training of a third policy determination model for determining the network policy according to the target image from among a plurality of previously determined network policies,
   the medium recording a program for,
   in performing training of the third policy determination model,
   inputting quality information of the target image for training to a trained first policy determination model for determining the network policy according to quality information of the target image from among a plurality of previously determined network policies, and deriving a likelihood of each of the network policies as a correct answer likelihood,
   inputting the target image for training to a third policy determination model, and deriving a likelihood of each network policy as a likelihood during training, and
   updating a parameter of a third policy determination model, based on a fourth loss, in such a way that the likelihood during training approaches the correct answer likelihood, wherein
   the fourth loss is a loss based on an error between the likelihood during training and the correct answer likelihood.

This application is based upon and claims the benefit of priority from PCT/JP2022/041157, filed on Nov. 4, 2022, the disclosure of which is incorporated herein in its entirety by reference.

### REFERENCE SIGNS LIST

100, 400, 500, 600 Information processing system
101 Capture apparatus
102, 403, 503, 603 Information processing apparatus
111 Quality estimation unit
112 Policy determination unit
113 Image processing unit
113a First processing unit
113b Second processing unit
114 Recognition unit
421,521 Storage unit for training
422 Training unit
423 Policy-for-training determination unit
423a First determination unit
423b Second determination unit
524 Image selection unit
525 Policy-for-training determination unit
NN1 to NN3 Neural network

What is claimed is:

1. An information processing system comprising:
at least one apparatus including a memory configured to store instructions; and
a processor configured to execute the instructions to:
estimate quality information of a target image; and
process the target image by use of a neural network according to a network policy determined based on the quality information of the target image.

2. The information processing system according to claim 1, wherein
processing the target image includes extracting a feature vector from the target image by use of the neural network according to the network policy.

3. The information processing system according to claim 1, wherein
the target image is an eye image including an iris region in which an iris is shown, and
the quality information includes an iris diameter.

4. The information processing system according to claim 1, wherein
the quality information includes resolution of the target image.

5. The information processing system according to claim 1, wherein the processor further configured to execute the instructions to:
determine the network policy, based on the quality information.

6. The information processing system according to claim 5, wherein
the network policy is determined in such a way that a time of processing using the neural network falls within a previously determined range, regardless of quality information of the target image.

7. The information processing system according to claim 1, wherein
processing the target image includes
converting the iris region included in the target image into a standard image with a previously determined shape, and
processing the standard image by use of the neural network according to the network policy, and
converting the iris region into the standard image with a size according to the quality information.

8. The information processing system according to claim 1, wherein
the neural network is made up of a front-stage group including an input layer, and a rear-stage group including a final layer, and
the network policy is applied to image processing using the front-stage group.

9. The information processing system according to claim 8, wherein
the neural network includes a plurality of convolution layers, and
the network policy is determined in such a way that a number of the convolution layers included in the front-stage group is larger as resolution of the target image is lower.

10. The information processing system according to claim 8, wherein
the neural network includes a plurality of convolution layers, and
the network policy is determined in such a way that a number of channels in an arithmetic operation in the convolution layer included in the front-stage group is larger as resolution of the target image is lower.

11. The information processing system according to claim 1, wherein the processor further configured to execute the instructions to:
perform training of the neural network by inputting a target image for training to the neural network.

12. The information processing system according to claim 11, wherein the processor further configured to execute the instructions to:
determine a network policy regarding the target image for training, based on quality information of the target image for training and a probability distribution for training,
training unit performs training of the neural network is performed by inputting the target image for training to the neural network according to the determined network policy, and
the probability distribution for training is a probability distribution being highest in probability with quality indicated by quality information of the target image for training, and becoming gradually lower in probability as a degree of being different from the quality becomes larger.

13. The information processing system according to claim 12, wherein
training of the neural network further includes
changing quality information of the target image for training according to a probability distribution for training by using the random number, and determines quality information for training, and
determining a network policy regarding the target image for training according to the determined quality information for training.

14. The information processing system according claim 11, wherein the processor further configured to execute the instructions to:
select a target image for training in such a way that more target images for training with lower quality are selected, wherein
perform training of the neural network by inputting the selected target image for training to the neural network.

15. The information processing system according to claim 11, wherein the processor further configured to execute the instructions to:
perform training of a first policy determination model for determining the network policy according to quality information of the target image from among a plurality of previously determined network policies; and
derive a first loss in a case where the target image for training is processed by use of a neural network according to each of the plurality of network policies, wherein
the first policy determination model is configured from a neural network,
performing training of a first policy determination model includes
inputting quality information of the target image for training to the first policy determination model, and derives a likelihood of each network policy,
and
updating a parameter of the first policy determination model, based on the first loss and the likelihood of each of the network policies, and
updating the parameter of the first policy determination model includes
deriving a second loss being a sum acquired by weighting a first loss with a likelihood regarding each of the network policies, and
updating a parameter of the first policy determination model, based on the second loss.

16. The information processing system according to claim 11, wherein the processor further configured to execute the instructions to:
perform training of a second policy determination model for determining the network policy according to quality information of the target image from among a plurality of previously determined network policies; and
derive a first loss in a case where the target image for training is processed by use of a neural network according to the network policy determined by use of the second policy determination model, wherein
the second policy determination model is made up of a plurality of policy probability distributions each being related to each of the plurality of network policies,
each of the plurality of policy probability distributions includes one or more parameters,
performing training of the second policy determination model includes
deriving a likelihood of each policy probability distribution by use of quality information of the target image for training and each of the plurality of policy probability distributions, and
updating the parameter of each of the policy probability distributions, based on the first loss, and a correction loss for correcting in such a way that a difference of parameters of policy probability distributions being relevant to different network policies becomes larger, and
updating the parameter of each of the policy probability distributions includes
deriving a third loss by adding the first loss and a correction loss, and
updating the parameter of each of the policy probability distributions, based on the third loss.

17. The information processing system according to claim 11, wherein the processor further configured to execute the instructions to:
perform training of a third policy determination model for determining the network policy according to the target image from among a plurality of previously determined network policies, wherein
training of the third policy determination model includes
inputting quality information of the target image for training to a trained first policy determination model for determining the network policy according to quality information of the target image from among a plurality of previously determined network policies, and derives a likelihood of each of the network policies as a correct answer likelihood,
inputting the target image for training to a third policy determination model, and derives a likelihood of each network policy as a likelihood during training, and
updating a parameter of a third policy determination model, based on a fourth loss, in such a way that the likelihood during training approaches the correct answer likelihood, and
the fourth loss is a loss based on an error between the likelihood during training and the correct answer likelihood.

18. (canceled)

19. An information processing method comprising,
by one or more computers:
estimating quality information of a target image; and
processing the target image by use of a neural network according to a network policy determined based on the quality information of the target image.

20. A medium recording a program for causing one or more computers to execute:
estimating quality information of a target image; and
processing the target image by use of a neural network according to a network policy determined based on the quality information of the target image.
